(19) United States
(12) Patent Application Publication
(10) Pub. No.: US 2024/0276357 A1
(43) Pub. Date: Aug. 15, 2024

(54) MODEL SELECTION AND DELIVERY

(71) Applicant: QUALCOMM Incorporated, San Diego, CA (US)

(72) Inventors: Rajeev KUMAR, San Diego, CA (US); Aziz GHOLMIEH, Del Mar, CA (US); Gavin Bernard HORN, La Jolla, CA (US); Miguel GRIOT, La Jolla, CA (US)

(21) Appl. No.: 18/409,457

(22) Filed: Jan. 10, 2024

Related U.S. Application Data
(60) Provisional application No. 63/484,879, filed on Feb. 14, 2023.

(51) Int. Cl. H04W 48/18; H04L 27/26; H04W 8/22; H04W 48/20; H04W 60/04

(52) U.S. Cl. CPC H04W 48/18; H04L 27/26025; H04W 8/22; H04W 48/20; H04W 60/04

(57) ABSTRACT

Various aspects of the present disclosure generally relate to wireless communication. In some aspects, a mobility management function (MMF) of a core network entity may obtain a trigger for transmitting meta information associated with a model. The MMF may transmit, to an access and mobility management function (AMF) of the core network entity, an AMF service invoke message. The AMF may obtain an indication of one or more central network entities within an area. The AMF may transmit, to the one or more central network entities, meta information associated with the model. Numerous other aspects are described.

### CROSS-REFERENCE TO RELATED APPLICATION

This patent application claims priority to U.S. Provisional Patent Application No. 63/484,879, filed on Feb. 14, 2023, entitled “MODEL SELECTION AND DELIVERY,” and assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses for model selection and delivery.

### BACKGROUND

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and types of wireless communications mediums available for use, and the like. Consequently, there exists a need for further improvements in wireless communications systems to overcome the aforementioned technical challenges and others.

### SUMMARY

One aspect provides a method for wireless communication by a core network entity. The method includes obtaining, by a model management function (MMF) of the core network entity, a trigger for transmitting meta information associated with a model; transmitting, by the MMF to an access and mobility management function (AMF) of the core network entity, an AMF service invoke message; obtaining, by the AMF, an indication of one or more central network entities within an area; and transmitting, by the AMF to the one or more central network entities, meta information associated with the model.

Another aspect provides a method for wireless communication by a central network entity. The method includes transmitting, to an AMF of a core network entity, a request for meta information associated with a model; and receiving, from the AMF, the meta information associated with the model.

Another aspect provides a method for wireless communication by a user equipment (UE). The method includes transmitting, to an AMF of a core network entity, a model query; receiving, from the AMF, a model query response; and selecting a model based at least in part on the model query response.

Another aspect provides a method for wireless communication by a core network entity. The method includes receiving, by an AMF of the core network entity from a UE, a model query, transmitting, by the AMF to an MMF of the core network entity, the model query; selecting, by the MMF, a model; transmitting, by the MMF to the AMF, a model query response; and transmitting, by the AMF, the model query response.

Another aspect provides a method for wireless communication by a network entity. The method includes selecting, by a service management and orchestration (SMO) function of the network entity, a model; and transmitting, by the SMO function of the network entity, an indication of the model.

Another aspect provides a method for wireless communication by a central network entity. The method includes receiving, from a UE, UE capability information; selecting a model based at least in part on the UE capability information; transmitting, to a core network entity, a model delivery request message; and receiving, from the UE, a model delivery complete indication.

Another aspect provides a method for wireless communication by a core network entity. The method includes receiving, by an AMF of the core network entity from a central network entity, a model delivery request message; and transmitting, by the AMF, a model delivery message that includes an indication of a model.

Other aspects provide: an apparatus operable, configured, or otherwise adapted to perform any one or more of the aforementioned methods and/or those described herein with reference to and as illustrated by the drawings and specification; a non-transitory, computer-readable medium comprising computer-executable instructions that, when executed by a processor of an apparatus, cause the apparatus to perform the aforementioned methods and/or those described herein with reference to and as illustrated by the drawings and specification; a computer program product embodied on a computer-readable storage medium comprising code for performing the aforementioned methods and/or those described herein with reference to and as illustrated by the drawings and specification; and/or an apparatus comprising means for performing the aforementioned methods and/or those described herein with reference to and as illustrated by the drawings and specification. By way of example, an apparatus may comprise a processing system, a device with a processing system, or processing systems cooperating over one or more networks.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 depicts an example of a wireless communications network, in accordance with the present disclosure.

FIG. 2 depicts aspects of an example base station and user equipment (UE), in accordance with the present disclosure.

FIG. 3 depicts an example disaggregated base station architecture.

FIGS. 4A, 4B, 4C, and 4D depict aspects of data structures for a wireless communications network, such as wireless communications network of FIG. 1.

FIG. 5 is a diagram illustrating an example of providing a central network entity with meta information.

FIG. 6 is a diagram illustrating an example of UE triggered model and meta information downloading from a core network.

FIG. 7 is a diagram illustrating an example of central network entity triggered model downloading.

FIG. 8 is a diagram illustrating an example of a core network function providing a model to a UE based at least in part on a request from a central network entity.

FIG. 9 is a diagram illustrating an example of a core network function initiating a model delivery.

FIG. 10 is a diagram illustrating an example of a central network entity initiated model transfer from a core network.

FIG. 11 is a diagram illustrating an example of a central network entity initiated model transfer from a core network.

FIG. 12 is a diagram illustrating an example of model delivery based at least in part on meta information stored at a core network entity.

FIG. 13 is a diagram illustrating an example of a central network entity initiated model transfer from a core network.

FIG. 14 shows a method for wireless communications by a core network entity.

FIG. 15 shows a method for wireless communications by a central network entity.

FIG. 16 shows a method for wireless communications by a UE.

FIG. 17 shows a method for wireless communications by a core network entity.

FIG. 18 shows a method for wireless communications by a network entity.

FIG. 19 shows a method for wireless communications by a central network entity.

FIG. 20 shows a method for wireless communications by a UE.

FIG. 21 is a diagram illustrating an example of an implementation of code and circuitry for a communications device.

FIG. 22 is a diagram illustrating an example of an implementation of code and circuitry for a communications device.

FIG. 23 is a diagram illustrating an example of an implementation of code and circuitry for a communications device.

FIG. 24 is a diagram illustrating an example of an implementation of code and circuitry for a communications device.

FIG. 25 is a diagram illustrating an example of an implementation of code and circuitry for a communications device.

FIG. 26 is a diagram illustrating an example of an implementation of code and circuitry for a communications device.

FIG. 27 is a diagram illustrating an example of an implementation of code and circuitry for a communications device.

### DETAILED DESCRIPTION

Aspects of the present disclosure provide apparatuses, methods, processing systems, and computer-readable mediums for model selection and delivery.

A model, such as an artificial intelligence (AI) or machine learning (ML) model, and/or information associated with the model, may be communicated between a UE and one or more network entities, such as a central network entity and/or a core network entity. The information associated with the model may be meta information that describes how the model is to be used by the UE. For example, the meta information may indicate a scenario, configuration, setting, or zone associated with the model. Additionally, or alternatively, the meta information may indicate information associated with an operation of the model, such as sub-carrier spacing (SCS) information, antenna information, carrier information, or bandwidth part (BWP) information, among other examples.

Various delivery methods for the model and/or meta information may be considered. In one example, the model may be communicated between the UE and a central network entity. In another example, the model may be communicated between the UE and a core network entity. In another example, the model may be communicated between the UE and a location management function (LMF). In another example, the model may be communicated between the UE and a server. However, current network interfaces do not support these model delivery methods. For example, current network interfaces may not support the communication of event triggers, model queries, or meta information updates, among other examples, for model selection and delivery. Thus, communicating the model and/or the meta information between the UE, the central network entity, and the core network entity may be difficult or may not be possible.

Techniques and apparatuses are described herein for model selection and delivery. In some aspects, a core network entity may transmit model and/or meta information associated with the model to a UE. For example, a model management function (MMF) of the core network entity may receive an event trigger, and an access and mobility management function (AMF) of the core network entity may identify one or more central network entities within an area (e.g., a service area or a geographic area) of the UE. The AMF may instruct the one or more central network entities to provide the model or the meta information to the UE. In some other aspects, the MMF may select a model to be used by the UE, and the AMF may transmit the model or the meta information to the UE. In some other aspects, the central network entity may transmit an indication of a model to be used by the UE, and the UE may request and receive the model from the AMF or the MMF. In some other aspects, the UE may request and receive the model or meta information from a service management and orchestration (SMO) function. Other example model selection and delivery methods are described herein.

Using the techniques and apparatuses described herein, the UE, the central network entity, and/or the core network entity may communicate meta information (or other model information, such as a model identifier) for AI/ML model delivery and updating. For example, the UE, the central network entity, and the core network entity may communicate event triggers, model queries, or meta information, among other examples, to be used for model selection and delivery. This may enable the UE to receive the model or the meta information from the network entities, and to use the model in accordance with the meta information, such as in accordance with the scenario, configuration, setting, or zone associated with the model.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

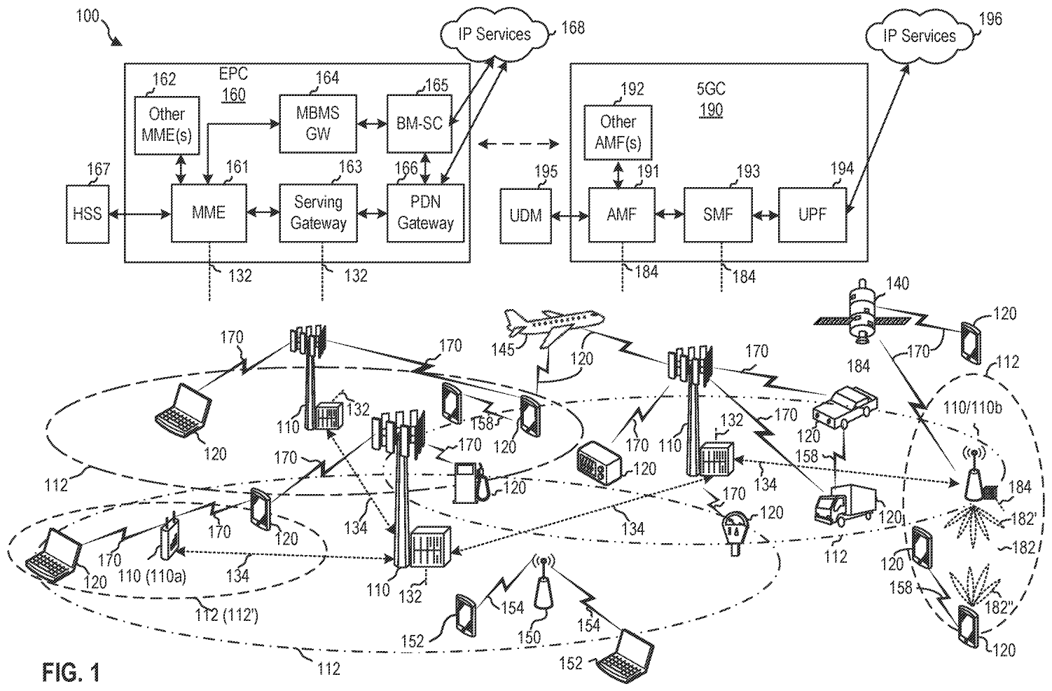

FIG. 1 depicts an example of a wireless communications network 100, in accordance with the present disclosure.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 110), and non-terrestrial aspects, such as satellite 140 and aircraft 145, which may include network entities on-board (e.g., one or more BSs) capable of communicating with other network elements (e.g., terrestrial BSs) and UEs.

In the depicted example, wireless communications network 100 includes BSs 110, UEs 120, and one or more core networks, such as an Evolved Packet Core (EPC) 160 and 5G Core (5GC) 190, which interoperate to provide communications services over various communications links, including wired and wireless links.

FIG. 1 depicts various example UEs 120, which may include a cellular phone, a smart phone, a session initiation protocol (SIP) phone, a laptop, a personal digital assistant (PDA), a satellite radio, a global positioning system (GPS), a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an internet of things (IoT) device, an always on (AON) device, an edge processing device, or another similar device. A UE 120 may also be referred to as a mobile device, a wireless device, a wireless communication device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, or a handset, among other examples.

BSs 110 may wirelessly communicate with (e.g., transmit signals to or receive signals from) UEs 120 via communications links 170. The communications links 170 between BSs 110 and UEs 120 may carry uplink (UL) (also referred to as reverse link) transmissions from a UE 120 to a BS 110 and/or downlink (DL) (also referred to as forward link) transmissions from a BS 110 to a UE 120. The communications links 170 may use multiple-input and multiple-output (MIMO) antenna technology, including spatial multiplexing, beamforming, and/or transmit diversity in various aspects.

A BS 110 may include, for example, a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point, and/or others. A BS 110 may provide communications coverage for a respective geographic coverage area 112, which may sometimes be referred to as a cell, and which may overlap in some cases (e.g., a small cell provided by a BS 110a may have a coverage area 112′ that overlaps the coverage area 112 of a macro cell). A BS 110 may, for example, provide communications coverage for a macro cell (covering a relatively large geographic area), a pico cell (covering a relatively smaller geographic area, such as a sports stadium), a femto cell (covering a relatively smaller geographic area (e.g., a home)), and/or other types of cells.

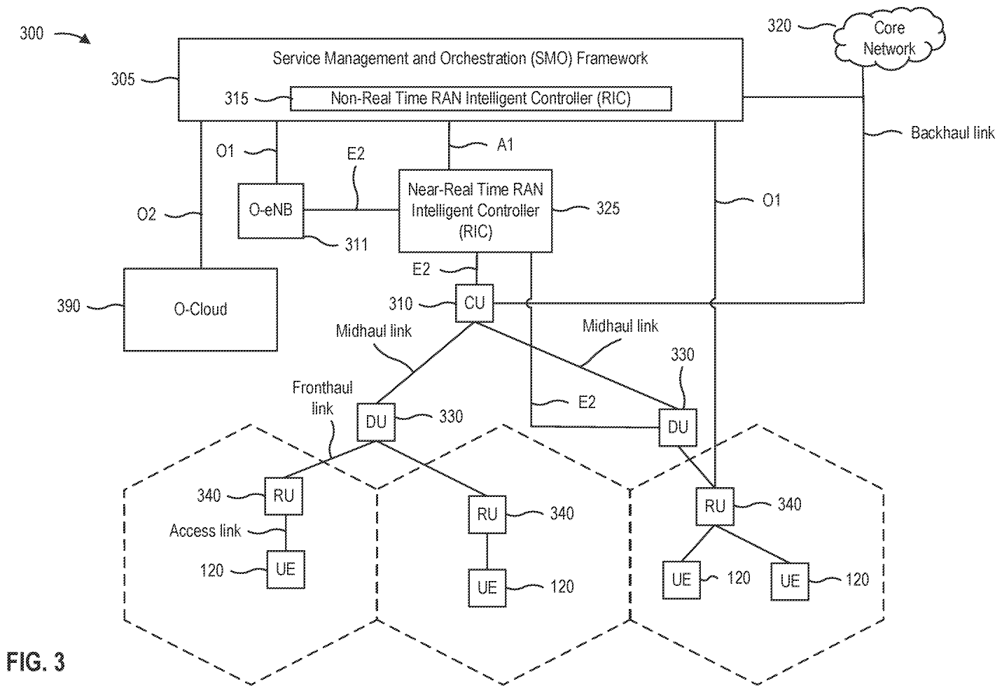

While BSs 110 are depicted in various aspects as unitary communications devices, BSs 110 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a BS (e.g., BS 110) may include components that are located at a single physical location or components located at various physical locations. In examples in which a BS includes components that are located at various physical locations, the various components may each perform functions such that, collectively, the various components achieve functionality that is similar to a BS that is located at a single physical location. In some aspects, a BS including components that are located at various physical locations may be referred to as having a disaggregated radio access network architecture, such as an Open RAN (O-RAN) architecture or a Virtualized RAN (VRAN) architecture. FIG. 3 depicts and describes an example disaggregated BS architecture.

Different BSs 110 within wireless communications network 100 may also be configured to support different radio access technologies, such as 3G, 4G, and/or 5G, among other examples. For example, BSs 110 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 110 configured for 5G (e.g., 5G NR or Next Generation RAN (NG-RAN)) may interface with 5GC 190 through second backhaul links 184. BSs 110 may communicate directly or indirectly (e.g., through the EPC 160 or 5GC 190) with each other over third backhaul links 134 (e.g., X2 interfaces), which may be wired or wireless.

Wireless communications network 100 may subdivide the electromagnetic spectrum into various classes, bands, channels, or other features. In some aspects, the subdivision is based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-52,600 MHz, which is sometimes referred to (interchangeably) as a “millimeter wave” (“mmW” or “mmWave”). A base station configured to communicate using mmWave or near mmWave radio frequency bands (e.g., a mmWave base station such as BS 110b) may utilize beamforming (e.g., as shown by 182) with a UE (e.g., 120) to improve path loss and range.

The communications links 170 between BSs 110 and, for example, UEs 120, may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. In some examples, allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 110b in FIG. 1) may utilize beamforming with a UE 120 to improve path loss and range, as shown at 182. For example, BS 110b and the UE 120 may each include a plurality of antennas, such as antenna elements, antenna panels, and/or antenna arrays to facilitate the beamforming. In some cases, BS 110b may transmit a beamformed signal to UE 120 in one or more transmit directions 182′. UE 120 may receive the beamformed signal from the BS 110b in one or more receive directions 182″. UE 120 may also transmit a beamformed signal to the BS 110b in one or more transmit directions 182″. BS 110b may also receive the beamformed signal from UE 120 in one or more receive directions 182′. BS 110b and UE 120 may then perform beam training to determine the best receive and transmit directions for each of BS 110b and UE 120. Notably, the transmit and receive directions for BS 110b may or may not be the same. Similarly, the transmit and receive directions for UE 120 may or may not be the same.

Wireless communications network 100 further includes a Wi-Fi access point (AP) 150 in communication with Wi-Fi stations (STAs) 152 via communications links 154 in, for example, a 2.4 GHz and/or 5 GHz unlicensed frequency spectrum.

Certain UEs 120 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 161, other MMEs 162, a Serving Gateway 163, a Multimedia Broadcast Multicast Service (MBMS) Gateway 164, a Broadcast Multicast Service Center (BM-SC) 165, and/or a Packet Data Network (PDN) Gateway 166, such as in the depicted example. MME 161 may be in communication with a Home Subscriber Server (HSS) 167. MME 161 is a control node that processes the signaling between the UEs 120 and the EPC 160. Generally, MME 161 provides bearer and connection management.

Generally, user Internet protocol (IP) packets are transferred through Serving Gateway 163, which is connected to PDN Gateway 166. PDN Gateway 166 provides UE IP address allocation as well as other functions. PDN Gateway 166 and the BM-SC 165 are connected to IP Services 168, which may include, for example, the Internet, an intranet, an IP Multimedia Subsystem (IMS), a Packet Switched (PS) streaming service, and/or other IP services.

BM-SC 165 may provide functions for MBMS user service provisioning and delivery. BM-SC 165 may serve as an entry point for content provider MBMS transmission, may be used to authorize and initiate MBMS Bearer Services within a public land mobile network (PLMN), and/or may be used to schedule MBMS transmissions. MBMS Gateway 164 may distribute MBMS traffic to the BSs 110 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an AMF 191, other AMFs 192, a Session Management Function (SMF) 193, and a User Plane Function (UPF) 194. AMF 191 may be in communication with Unified Data Management (UDM) 195.

AMF 191 is a control node that processes signaling between UEs 120 and 5GC 190. AMF 191 provides, for example, quality of service (QoS) flow and session management.

IP packets are transferred through UPF 194, which is connected to the IP Services 196, and which provides UE IP address allocation as well as other functions for 5GC 190. IP Services 196 may include, for example, the Internet, an intranet, an IMS, a PS streaming service, and/or other IP services.

In various aspects, a network entity or network node can be implemented as an aggregated base station, a disaggregated base station, a component of a base station, an integrated access and backhaul (IAB) node, a relay node, a sidelink node, a transmission reception point (TRP), or a combination thereof, to name a few examples.

As indicated above, FIG. 1 is provided as an example. Other examples may differ from what is described with regard to FIG. 1.

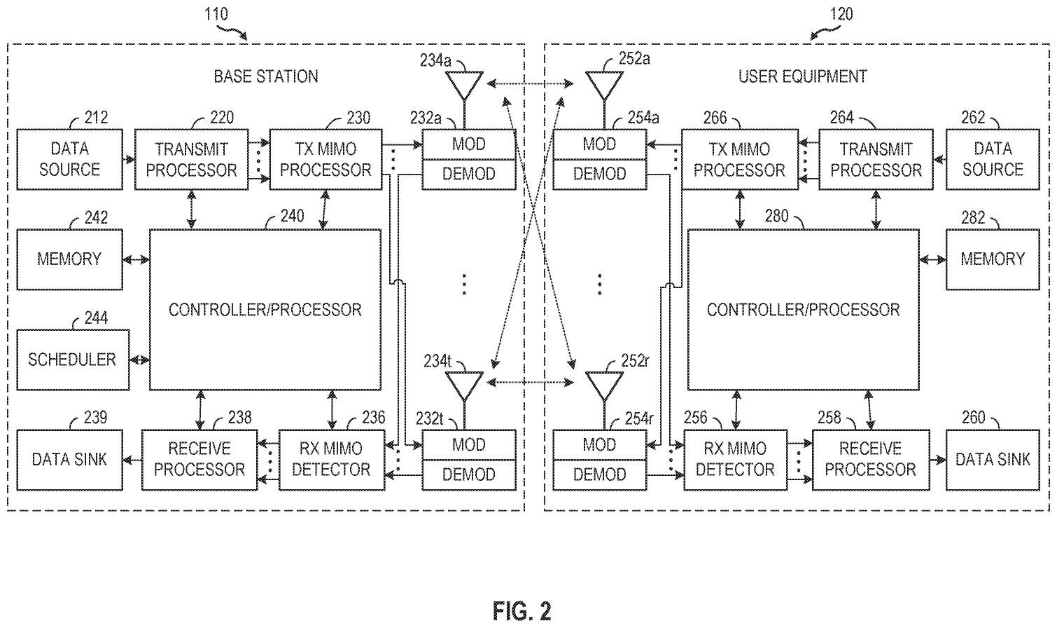

FIG. 2 depicts aspects of an example BS 110 and UE 120, in accordance with the present disclosure.

Generally, BS 110 includes various processors (e.g., 220, 230, 238, and 240), antennas 234a-t (collectively 234), transceivers 232a-t (collectively 232), which include modulators and demodulators, and other aspects, which enable wireless transmission of data (e.g., data source 212) and wireless reception of data (e.g., data sink 239). For example, BS 110 may send and receive data between BS 110 and UE 120. BS 110 includes controller/processor 240, which may be configured to implement various functions described herein related to wireless communications.

Generally, UE 120 includes various processors (e.g., 258, 264, 266, and 280), antennas 252a-r (collectively 252), transceivers 254a-r (collectively 254), which include modulators and demodulators, and other aspects, which enable wireless transmission of data (e.g., retrieved from data source 262) and wireless reception of data (e.g., provided to data sink 260). UE 120 includes controller/processor 280, which may be configured to implement various functions described herein related to wireless communications.

For an example downlink transmission, BS 110 includes a transmit processor 220 that may receive data from a data source 212 and control information from a controller/processor 240. The control information may be for the physical broadcast channel (PBCH), the physical control format indicator channel (PCFICH), the physical hybrid automatic repeat request (HARQ) indicator channel (PHICH), the physical downlink control channel (PDCCH), the group common PDCCH (GC PDCCH), and/or other channels. The data may be for the physical downlink shared channel (PDSCH), in some examples.

Transmit processor 220 may process (e.g., encode and symbol map) the data and control information to obtain data symbols and control symbols, respectively. Transmit processor 220 may also generate reference symbols, such as for the primary synchronization signal (PSS), the secondary synchronization signal (SSS), the PBCH demodulation reference signal (DMRS), or the channel state information reference signal (CSI-RS).

Transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream to obtain an output sample stream. Each modulator may further process (e.g., convert to analog, amplify, filter, and upconvert) the output sample stream to obtain a downlink signal. Downlink signals from the modulators in transceivers 232a-232t may be transmitted via the antennas 234a-234t, respectively.

UE 120 includes antennas 252a-252r that may receive the downlink signals from the BS 110 and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples to obtain received symbols.

MIMO detector 256 may obtain received symbols from all the demodulators in transceivers 254a-254r, perform MIMO detection on the received symbols if applicable, and provide detected symbols. Receive processor 258 may process (e.g., demodulate, deinterleave, and decode) the detected symbols, provide decoded data for the UE 120 to a data sink 260, and provide decoded control information to a controller/processor 280.

For an example uplink transmission, UE 120 further includes a transmit processor 264 that may receive and process data (e.g., for the physical uplink shared channel (PUSCH)) from a data source 262 and control information (e.g., for the physical uplink control channel (PUCCH)) from the controller/processor 280. Transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM), and transmitted to BS 110.

At BS 110, the uplink signals from UE 120 may be received by antennas 234a-234t, processed by the demodulators in transceivers 232a-232t, detected by a MIMO detector 236 if applicable, and further processed by a receive processor 238 to obtain decoded data and control information sent by UE 120. Receive processor 238 may provide the decoded data to a data sink 239 and the decoded control information to the controller/processor 240. Memories 242 and 282 may store data and program codes (e.g., processor-executable instructions, computer-executable instructions) for BS 110 and UE 120, respectively. Scheduler 244 may schedule UEs for data transmission on the downlink and/or uplink.

In various aspects, BS 110 may be described as transmitting and receiving various types of data associated with the methods described herein. In these contexts, “transmitting” may refer to various mechanisms of outputting data, such as outputting data from data source 212, scheduler 244, memory 242, transmit processor 220, controller/processor 240, TX MIMO processor 230, transceivers 232a-t, antenna 234a-t, and/or other aspects described herein. Similarly, “receiving” may refer to various mechanisms of obtaining data, such as obtaining data from antennas 234a-t, transceivers 232a-t, RX MIMO detector 236, controller/processor 240, receive processor 238, scheduler 244, memory 242, a network interface, and/or other aspects described herein.

In various aspects, UE 120 may likewise be described as transmitting and receiving various types of data associated with the methods described herein. In these contexts, “transmitting” may refer to various mechanisms of outputting data, such as outputting data from data source 262, memory 282, transmit processor 264, controller/processor 280, TX MIMO processor 266, transceivers 254a-t, antenna 252a-t, and/or other aspects described herein. Similarly, “receiving” may refer to various mechanisms of obtaining data, such as obtaining data from antennas 252a-t, transceivers 254a-t, RX MIMO detector 256, controller/processor 280, receive processor 258, memory 282, and/or other aspects described herein.

In some aspects, a processor may be configured to perform various operations, such as those associated with the methods described herein, and transmit (output) data to or receive (obtain) data from another interface that is configured to transmit or receive, respectively, the data.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “memory” or “a memory” should be understood to refer to “one or more memories.” Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

FIG. 3 depicts an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with an SMO Framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 120 via one or more radio frequency (RF) access links. In some implementations, the UE 120 may be simultaneously served by multiple RUs 340.

Each of the units (e.g., the CUs 310, the DUs 330, the RUs 340, as well as the Near-RT RICs 325, the Non-RT RICs 315 and the SMO Framework 305) may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., Central Unit-User Plane (CU-UP)), control plane functionality (e.g., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over-the-air (OTA) communications with one or more UEs 120. In some implementations, real-time and non-real-time aspects of control and user plane communications with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, artificial intelligence/machine learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

As indicated above, FIG. 3 is provided as an example. Other examples may differ from what is described with regard to FIG. 3.

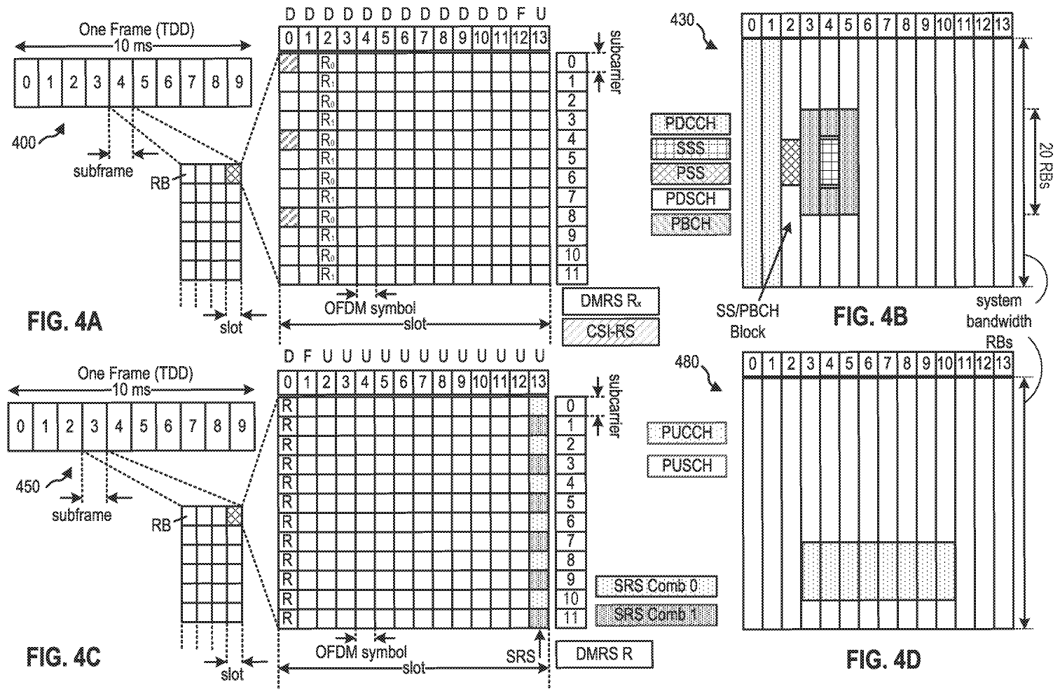

FIGS. 4A, 4B, 4C, and 4D depict aspects of data structures for a wireless communications network, such as wireless communications network 100 of FIG. 1, in accordance with the present disclosure. FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and F is flexible for use between DL/UL. UEs may be configured with a slot format through a received slot format indicator (SFI) (dynamically through DL control information (DCI), or semi-statically/statically through RRC signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}×15 kHz, where μ is the numerology index, which may be selected from values 0 to 5. Accordingly, the numerology μ=0 has a subcarrier spacing of 15 kHz and the numerology μ=5 has a subcarrier spacing of 480 kHz. Other numerologies and subcarrier spacings may be used. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RSs) for a UE (e.g., UE 120). The RSs may include demodulation RSs (DMRSs) and/or channel state information reference signals (CSI-RSs) for channel estimation at the UE. The RSs may also include beam measurement RSs (BRSs), beam refinement RSs (BRRSs), and/or phase tracking RSs (PT-RSs).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., UE 120) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRSs. The physical broadcast channel (PBCH), which carries a master information block (MIB), may be logically grouped with the PSS and SSS to form a synchronization signal (SS)/PBCH block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRSs (indicated as R for one particular configuration, but other DMRS configurations are possible) for channel estimation at the base station. The UE may transmit DMRSs for the PUCCH and DMRSs for the PUSCH. The PUSCH DMRSs may be transmitted, for example, in the first one or two symbols of the PUSCH. The PUCCH DMRSs may be transmitted in different configurations depending on whether short or long PUCCHs are transmitted and depending on the particular PUCCH format used. UE 120 may transmit sounding reference signals (SRSs). The SRSs may be transmitted, for example, in the last symbol of a subframe. The SRSs may have a comb structure, and a UE may transmit SRSs on one of the combs. The SRSs may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

As indicated above, FIGS. 4A-4D are provided as examples. Other examples may differ from what is described with regard to FIGS. 4A-4D.

A model, such as an AI/ML model, and/or information associated with the model, may be communicated between a UE and one or more network entities, such as a central network entity and/or a core network entity. The information associated with the model may be meta information that describes how the model is to be used by the UE. For example, the meta information may indicate a scenario, configuration, setting, or zone associated with the model. Additionally, or alternatively, the meta information may indicate information associated with an operation of the model, such as SCS information, antenna information, carrier information, or BWP information, among other examples.

In some cases, multiple models or model structures may be defined for a machine learning function name (MLFN). In some cases, a single model structure may be associated with multiple parameter sets (e.g., each parameter set having different weights). During operations, one or more models may be used by the UE based at least in part the scenario, the configuration, the setting, and/or the zone associated with the model. Additionally, or alternatively, the one or more models may be used by the UE based at least in part on the SCS information, the antenna information, the carrier information, or the BWP information.

Various delivery methods for the model and/or meta information may be considered. In one example, the model may be communicated between the UE and a central network entity. In another example, the model may be communicated between the UE and a core network entity. In another example, the model may be communicated between the UE and an LMF. In another example, the model may be communicated between the UE and a server. However, current network interfaces do not support these model delivery methods. For example, current network interfaces may not support the communication of event triggers, model queries, or meta information updates, among other examples, for model selection and delivery. Thus, communicating the model and/or the meta information between the UE, the central network entity, and the core network entity may be difficult or may not be possible.

Techniques and apparatuses are described herein for model selection and delivery. In some aspects, a core network entity may transmit model and/or meta information associated with the model to a UE. For example, an MMF of the core network entity may receive an event trigger, and an AMF of the core network entity may identify one or more central network entities within an area (e.g., a service area or a geographic area) of the UE. The AMF may instruct the one or more central network entities to provide the model or the meta information to the UE. In some other aspects, the MMF may select a model to be used by the UE, and the AMF may transmit the model or the meta information to the UE. In some other aspects, the central network entity may transmit an indication of a model to be used by the UE, and the UE may request and receive the model from the AMF or the MMF. In some other aspects, the UE may request and receive the model or meta information from an SMO. Other example model selection and delivery methods are described herein.

Using the techniques and apparatuses described herein, the UE, the central network entity, and/or the core network entity may communicate meta information (or other model information, such as a model identifier) for AI/ML model delivery and updating. For example, the UE, the central network entity, and the core network entity may communicate event triggers, model queries, or meta information, among other examples, to be used for model selection and delivery. This may enable the UE to receive the model or the meta information from the network entities, and to use the model in accordance with the meta information, such as in accordance with the scenario, configuration, setting, or zone associated with the model. Some examples of meta information availability, decision making, and model management are shown in Table 1 below.

TABLE 1

| | | Meta | | Model |
|---|---|---|---|---|
| | | information | Decision | management |
| Scenario | Goal/Objective | available at: | making at: | at: |
| Model | Provide NG-RAN with | MMF | — | — |
| delivery | meta information for the | | | |
| from the | UE models used at the | | | |
| core | NG-RAN. | | | |
| network | Obtain the model and | MMF, CN | MMF | MMF |
| (CN) to the | meta information from | | UE | |
| UE | the CN. | | provides | |
| | Send a request to | | information | |
| | MMF to obtain | | for model | |
| | model/meta | | selection | |
| | information. | | AMF may | |
| | Perform model | | provide | |
| | selection for the use at | | some | |
| | UE. | | additional | |
| | Update the UE | | information | |
| | capability to NG-RAN. | | upon request | |
| | | | to assist | |
| | | | decision. | |
| | UE obtains models from | NG-RAN | NG-RAN | MMF |
| | CN upon NG-RAN | | | |
| | request | | | |
| | NG-RAN requests UE | | | |
| | to download a model. | | | |
| | UE obtains the model | | | |
| | from MMF. | | | |
| | Acknowledge model | | | |
| | delivery. | | | |
| Model | NG-RAN request | NG-RAN, | If NG- | OAM/SMO |
| delivery | OAM/SMO to provide | OAM/SMO | RAN has | |
| from | model. | | meta | |
| OAM/SMO | OAM/SMO sends | | information | |
| | model to UE. | | available, | |
| | | | NG-RAN | |
| | | | may request | |
| | | | model | |
| | | | transfer by | |
| | | | providing | |
| | | | model ID | |
| | | | Else, NG- | |
| | | | RAN | |
| | | | provides | |
| | | | assistance | |
| | | | information. | |
| | OAM/SMO decides to | OAM/SMO | OAM/SMO | OAM/SMO |
| | initiate AI/ML | | NG-RAN | |
| | operations for a group | | provides | |
| | of UEs | | assistance | |
| | Requests assistance | | information. | |
| | information from NG- | | | |
| | RAN. | | | |
| | Initiates AI/ML based | | | |
| | operations by providing | | | |
| | model. | | | |

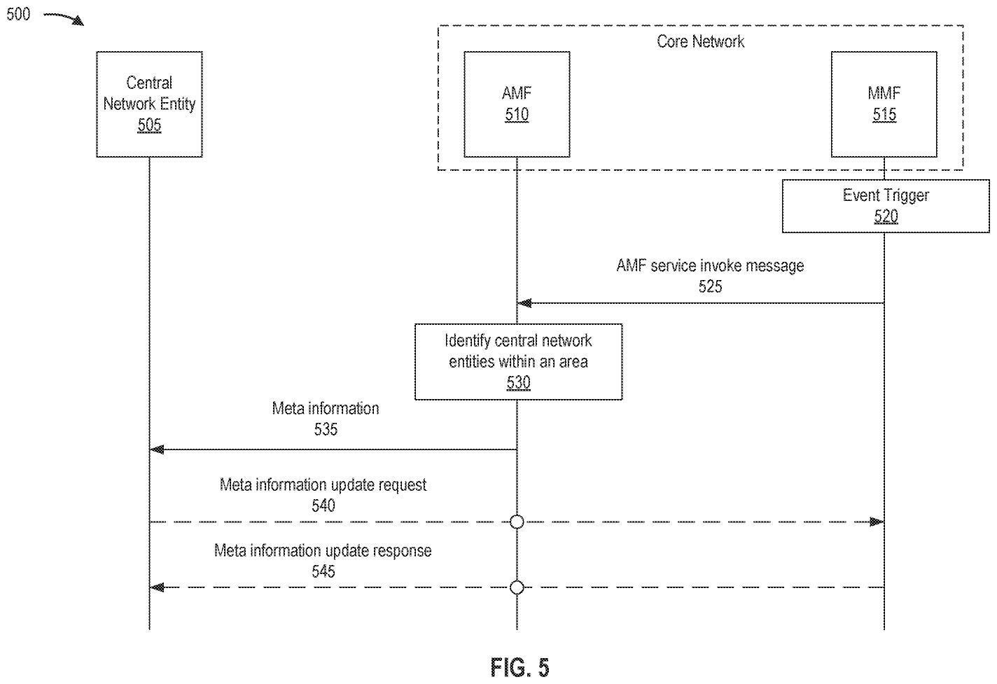

FIG. 5 is a diagram illustrating an example 500 of providing a central network entity with meta information, in accordance with the present disclosure. A central network entity 505 may communicate with an AMF 510 and/or an MMF 515. The central network entity 505 may be an NG-RAN node. The AMF 510 and the MMF 515 may be associated with a core network. For example, the AMF 510 may be an AMF of the core network and the MMF 515 may be an MMF of the core network. In some aspects, the AMF 510 and the MMF 515 may be other entities associated with the core network. For example, the AMF 510 may be a first core network entity and the MMF 515 may be a second core network entity.

As shown by reference number 520, the MMF 515 may obtain or detect an event trigger. The event trigger may be associated with a request for meta information associated with a model or an update to the meta information associated with the model.

As shown by reference number 525, the MMF 515 may transmit, and the AMF 510 may receive, an AMF service invoke message. The MMF 515 may transmit the AMF service invoke message based at least in part on obtaining or detecting the event trigger. The AMF service invoke message may include, for example, a meta information update. The meta information update may include information such as a model identifier associated with a model, a model identifier list that includes the identifier associated with the model, meta information associated with the model, and/or an area indication such as a service area indication or a geographical area indication.

As shown by reference number 530, the AMF 510 may determine or identify one or more central network entities within an area, such as the area indicated in the AMF service invoke message. The AMF 510 may identify or determine the one or more central network entities, such as the central network entity 505, based at least in part on receiving the service invoke message.

As shown by reference number 535, the AMF 510 may transmit, and the central network entity 505 may receive, meta information. The AMF 510 may transmit the meta information based at least in part on determining or identifying the one or more central network entities. In some aspects, the meta information may be associated with a meta information update, and may include, for example, the model identifier associated with the model and/or the model identifier list that includes the identifier associated with the model.

As shown by reference number 540, the central network entity 505 may transmit, and the core network (e.g., the AMF 510 and/or the MMF 515) may receive, a meta information update request. The meta information update request may include a model identifier associated with a model to be updated and/or a model identifier list that includes a model identifier associated with the model to be updated.

As shown by reference number 545, the core network (e.g., the AMF 510 and/or the MMF 515) may transmit, and the central network entity 505 may receive, a meta information update response. The core network may transmit the meta information update response based at least in part on receiving the meta information update request. The meta information update response may include, for example, meta information associated with the model indicated by the model identifier or the model identifier list.

In some aspects, the core network (e.g., the MMF 515) may provide meta information associated with a model to the central network entity 505 based at least in part on an event trigger, such as when meta information associated with the model changes, or based at least in part on a request from the central network entity 505, such as when the central network entity 505 requests to retrieve updated meta information associated with the model.

As indicated above, FIG. 5 is provided as an example. Other examples may differ from what is described with regard to FIG. 5.

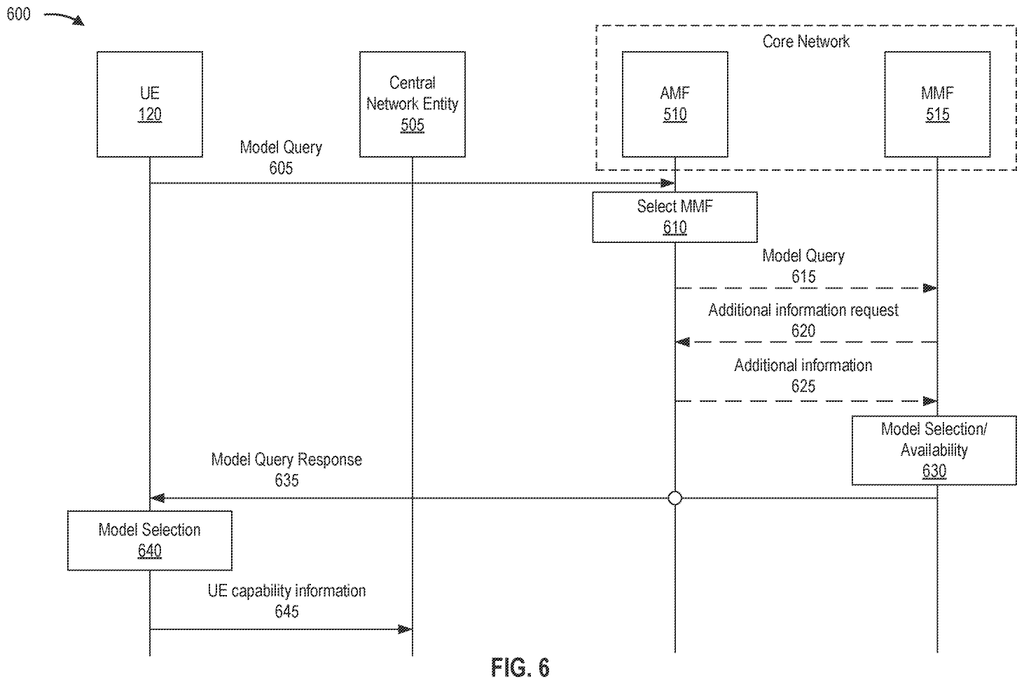

FIG. 6 is a diagram illustrating an example 600 of UE triggered model and meta information downloading from a core network, in accordance with the present disclosure.

As shown by reference number 605, the UE 120 may transmit, and the core network (e.g., the AMF 510 and/or the MMF 515) may receive, a model query. In some aspects, transmitting the model query may include transmitting an uplink non-access stratum (NAS) transport message, a class 1 NAS message, a class 2 NAS message, a class 1 message, or a class 2 message that includes the model query. The uplink NAS transport message, the class 1 NAS message, the class 2 NAS message, the class 1 message, or the class 2 message may include an MMF indication, information associated with the MMF, and/or the model query. The model query may include UE capability information and/or area information, among other examples. In some aspects, the uplink NAS transport message, the class 1 NAS message, the class 2 NAS message, the class 1 message, or the class 2 message may include a payload. In some aspects, the area information may include service area information or geographical area information. The geographical area information may be associated with a registration area, such as a tracking area indication (TAI) or a tracking area code (TAC).

As shown by reference number 610, the AMF 510 may select an MMF. The AMF 510 may select the MMF (e.g., the MMF 515) based at least in part on receiving the model query, such as based at least in part on receiving the uplink NAS transport message, the class 1 NAS message, the class 2 NAS message, the class 1 message, or the class 2 message that includes the model query.

As shown by reference number 615, the AMF 510 may transmit, and the MMF 515 may receive, the model query. The AMF 510 may transmit the model query to the MMF 515 based at least in part on selecting the MMF 515. In some aspects, the AMF 510 may forward the model query to the MMF 515 without processing the model query.

As shown by reference number 620, the MMF 515 may transmit, and the AMF 510 may receive, an additional information request. The MMF 515 may transmit the additional information request based at least in part on receiving the model query, such as based at least in part on receiving the uplink NAS transport message, the class 1 NAS message, the class 2 NAS message, the class 1 message, or the class 2 message that includes the model query. The additional information request may be a request for additional information associated with the geographical area, for example, when the model is valid only in a certain TAI.

As shown by reference number 625, the AMF 510 may transmit, and the MMF 515 may receive, the additional information. The AMF 510 may transmit the additional information based at least in part on receiving the request for the additional information.

As shown by reference number 630, the MMF 515 may perform a model selection and/or determine a model availability. The MMF 515 may select the model and/or determine the model availability based at least in part on receiving the model query, such as based at least in part on receiving the uplink NAS transport message, the class 1 NAS message, the class 2 NAS message, the class 1 message, or the class 2 message that includes the model query. The MMF 515 may select the model and/or determine the model availability based at least in part on information included in the model query, such as the UE capability information and/or the area information.

As shown by reference number 635, the core network (e.g., the AMF 510 and/or the MMF 515) may transmit, and the UE 120 may receive, a model query response. The core network may transmit the model query response based at least in part on selecting the model or determining that the model is available. The model query response may be included in a registration accept message, a downlink NAS transport message, a class 1 NAS message, a class 2 NAS message, a class 1 message, or a class 2 message. The downlink NAS transport message, class 1 NAS message, class 2 NAS message, class 1 message, or class 2 message may include the model, meta information associated with the model, and/or an identifier associated with the model.

As shown by reference number 640, the UE 120 may perform a model selection. The UE 120 may select the model based at least in part on receiving the registration accept message, the downlink NAS transport message, the class 1 NAS message, the class 2 NAS message, the class 1 message, or the class 2 message. The UE 120 may select the model based at least in part on the meta information associated with the model and/or the identifier associated with the model.

As shown by reference number 645, the UE 120 may transmit, and the central network entity 505 may receive, UE capability information. The UE 120 may transmit the UE capability information based at least in part on selecting the model. The UE capability information may be updated UE capability information associated with using the model. The UE 120 may determine and transmit the updated UE capability information based at least in part on the meta information.

As indicated above, FIG. 6 is provided as an example. Other examples may differ from what is described with regard to FIG. 6.

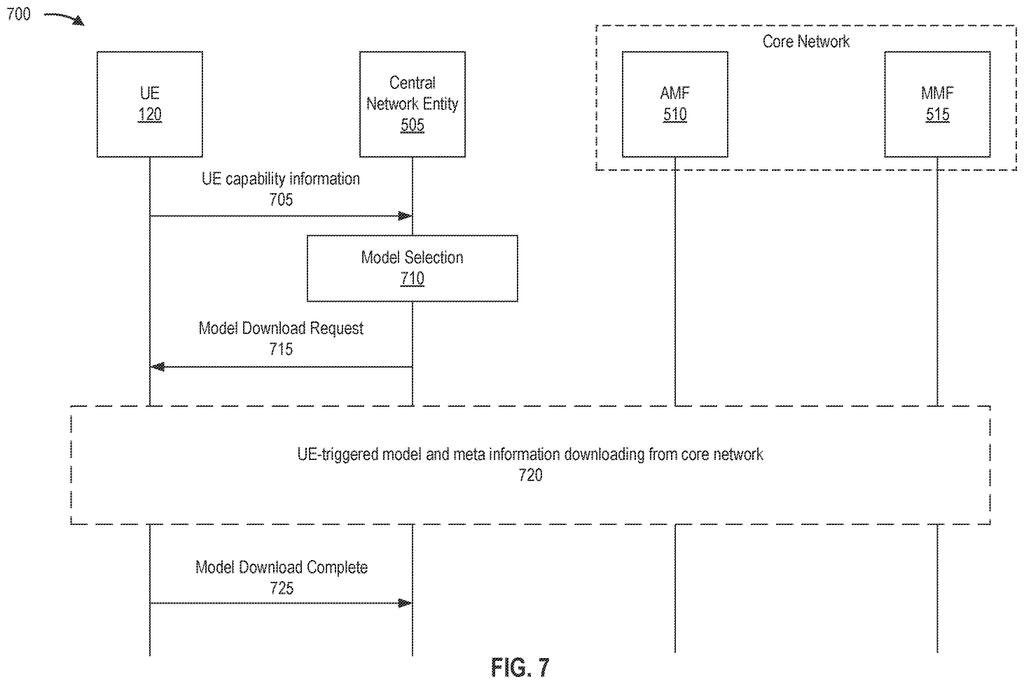

FIG. 7 is a diagram illustrating an example 700 of central network entity triggered model downloading, in accordance with the present disclosure.

As shown by reference number 705, the UE 120 may transmit, and the central network entity 505 may receive, UE capability information.

As shown by reference number 710, the central network entity 505 may perform a model selection. The central network entity 505 may select the model based at least in part on receiving the UE capability information.

As shown by reference number 715, the central network entity 505 may transmit, and the UE 120 may receive, a model download request. The central network entity 505 may transmit the model download request based at least in part on selecting the model.

As shown by reference number 720, the UE 120, the central network entity 505, the AMF 510, and/or the MMF 515 may perform UE-triggered model and meta information downloading from the core network. For example, the UE 120, the central network entity 505, the AMF 510, and the MMF 515 may perform one or more of the processes described above in connection with reference numbers 605, 610, 615, 620, 625, 630, 635, 640, and/or 645.

As shown by reference number 725, the UE 120 may transmit, and the central network entity 505 may receive, a model download complete message. The UE 120 may transmit the model download complete message based at least in part on downloading the model from the core network.

In some aspects, the central network entity 505 may request the UE 120 to download one or more models from the core network by sending, to the UE 120, a message that includes the model download request. The model download request may include a model identifier associated with the model (if known) and/or may include assistance information for supporting model selection at the MMF 515. The assistance information may include, for example, carrier frequency information (e.g., FR1 or FR2), SCS information, BWP information, antenna tilt information, antenna pattern information, scenario information, configuration information, or zone information, among other examples.

As indicated above, FIG. 7 is provided as an example. Other examples may differ from what is described with regard to FIG. 7.

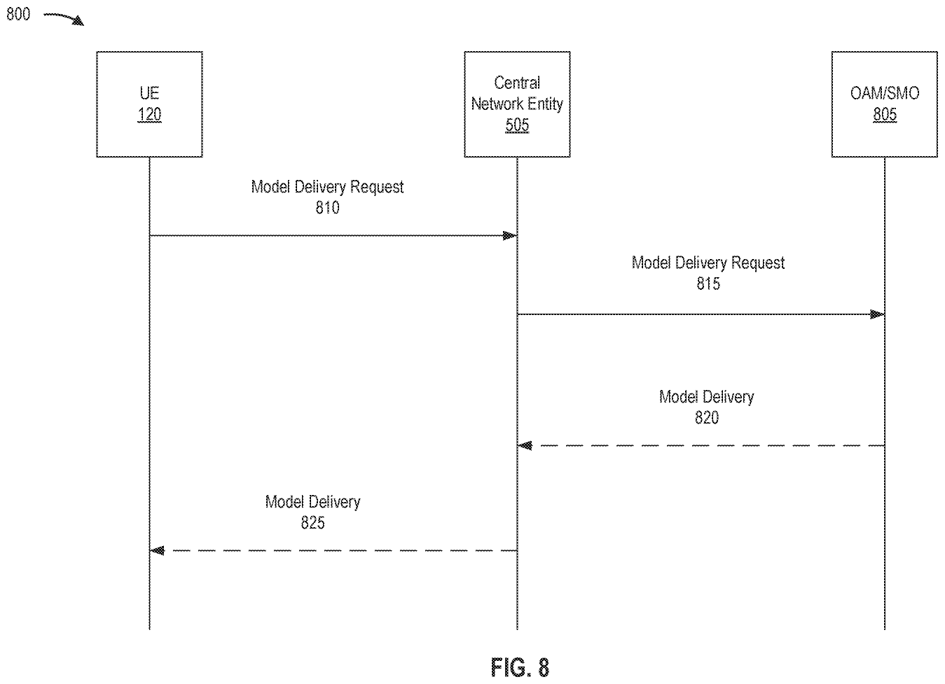

FIG. 8 is a diagram illustrating an example 800 of an OAM/SMO providing a model to a UE based at least in part on a request from a central network entity, in accordance with the present disclosure. The UE 120 and/or the central network entity 505 may communicate with an OAM/SMO 805.

As shown by reference number 810, the UE 120 may transmit, and the central network entity 505 may receive, a model delivery request.

As shown by reference number 815, the central network entity 505 may transmit, and the OAM/SMO 805 may receive, the model delivery request. The central network entity 505 may transmit the model delivery request to the OAM/SMO 805 based at least in part on receiving the model delivery request from the UE 120. The model delivery request may include a model identifier associated with a model and/or may include UE assistance information. The central network entity 505 may transmit the model delivery request to the OAM/SMO 805 using a class 1 message, a class 2 message, or a RAN intelligence controller (RIC) indication for near real time RIC, among other examples.

As shown by reference number 820, the OAM/SMO 805 may transmit, and the central network entity 505 may receive, a model delivery message. The model delivery message may include the model and/or meta information associated with the model. The OAM/SMO 805 may transmit the model delivery message based at least in part on receiving the model delivery request. The model delivery may be performed using control plane signaling or user plane signaling.

As shown by reference number 825, the central network entity 505 may transmit, and the UE 120 may receive, the model delivery message. The central network entity 505 may transmit the model delivery message to the UE 120 based at least in part on receiving the model delivery message from the OAM/SMO 805.

In some aspects, the central network entity 505 may request that the OAM/SMO 805 deliver the model to the UE 120 by providing a model identifier associated with the model or by providing UE assistance information to facilitate model selectin by the OAM/SMO 805.

As indicated above, FIG. 8 is provided as an example. Other examples may differ from what is described with regard to FIG. 8.

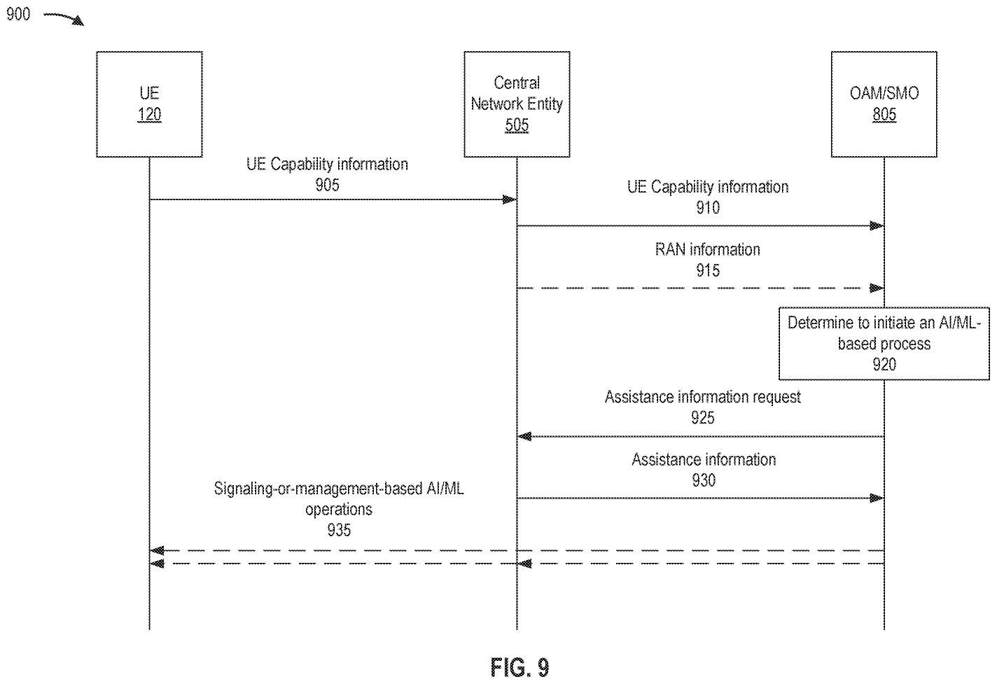

FIG. 9 is a diagram illustrating an example 900 of an OAM/SMO initiating a model delivery, in accordance with the present disclosure.

As shown by reference number 905, the UE 120 may transmit, and the central network entity 505 may receive, UE capability information.

As shown by reference number 910, the central network entity 505 may transmit, and the OAM/SMO 805 may receive, the UE capability information. The central network entity 505 may transmit the UE capability information to the OAM/SMO 805 based at least in part on receiving the UE capability information from the UE 120.

As shown by reference number 915, the central network entity 505 may transmit, and the OAM/SMO 805 may receive, RAN information. The central network entity 505 may transmit the RAN information based at least in part on a request from the OAM/SMO 805 for the RAN information. The RAN information may include, for example, UE context information and/or RAN configuration information, among other examples.

As shown by reference number 920, the OAM/SMO 805 may determine to initiate an AI/ML-based process. The OAM/SMO 805 may determine to initiate the AI/ML-based process based at least in part on receiving the UE capability information and/or the RAN information.

As shown by reference number 925, the OAM/SMO 805 may transmit, and the central network entity 505 may receive, an assistance information request. The OAM/SMO 805 may transmit the assistance information request based at least in part on determining to initiate the AI/ML-based process. The assistance information may be assistance information associated with performing a model selection.

As shown by reference number 930, the central network entity 505 may transmit, and the OAM/SMO 805 may receive, the assistance information. The central network entity 505 may transmit the assistance information to the OAM/SMO 805 based at least in part on receiving the assistance information request.

As shown by reference number 935, the OAM/SMO 805 may initiate signaling-or-management-based AI/ML operations. In some aspects, the OAM/SMO 805 may transmit an indication of the signaling-or-management-based AI/ML operations to the UE 120. Additionally, or alternatively, the OAM/SMO 805 may transmit an indication of the signaling-or-management-based AI/ML operations to the central network entity 505, and the central network entity 505 may forward the indication of the signaling-or-management-based AI/ML operations to the UE 120.

In some aspects, the OAM/SMO 805 may determine to initiate the AI/ML-based process for a group of UEs, for example, by accessing RAN and UE information from an RIC database. Based on the information available at the RIC database and/or UE assistance information, the OAM/SMO 805 may select a model and may deliver (e.g., transmit) the model to the UE 120. In some aspects, the signaling-or-management-based process may be used for an initialization of an AI/ML-based operation and/or for providing the model to the UE 120 (and/or other UEs).

As indicated above, FIG. 9 is provided as an example. Other examples may differ from what is described with regard to FIG. 9.

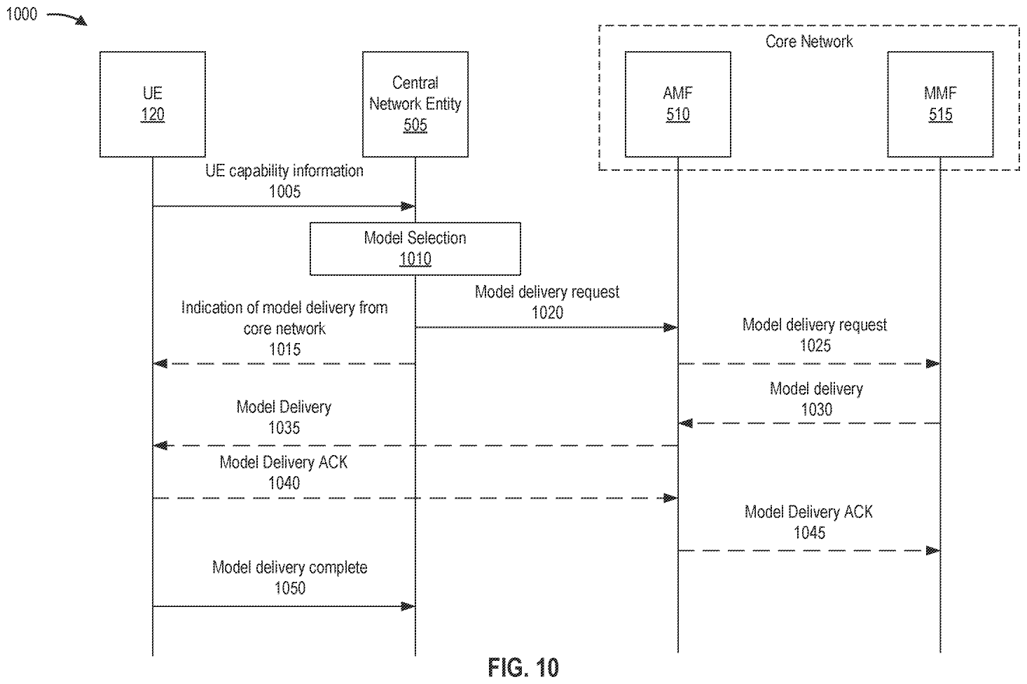

FIG. 10 is a diagram illustrating an example 1000 of a central network entity initiated model transfer from a core network, in accordance with the present disclosure.

As shown by reference number 1005, the UE 120 may transmit, and the central network entity 505 may receive, UE capability information.

As shown by reference number 1010, the central network entity 505 may perform a model selection. The central network entity 505 may select the model based at least in part on the UE capability information.

As shown by reference number 1015, the central network entity 505 may transmit, and the UE 120 may receive, an indication of model delivery from the core network. For example, the central network entity 505 may transmit an indication, to the UE 120, that the model is to be delivered to the UE 120 by the core network.

As shown by reference number 1020, the central network entity 505 may transmit, and the AMF 510 may receive, a model delivery request. The central network entity 505 may transmit the model delivery request based at least in part on selecting the model. The model delivery request may include a model identifier associated with the selected model.

As shown by reference number 1025, the AMF 510 may transmit, and the MMF 515 may receive, the model delivery request. The AMF 510 may transmit the model delivery request to the MMF 515 based at least in part on receiving the model delivery request from the central network entity 505. The model delivery request may include the model identifier associated with the selected model.

As shown by reference number 1030, the MMF 515 may transmit, and the AMF 510 may receive, a model delivery message. The MMF 515 may transmit the model delivery message based at least in part on receiving the model delivery request. The model delivery message may include the requested model or an indication of the requested model.

As shown by reference number 1035, the AMF 510 may transmit, and the UE 120 may receive, the model delivery message. The AMF 510 may transmit the model delivery message to the UE 120 based at least in part on receiving the model delivery message from the MMF 515. In some aspects, transmitting the model delivery message may include transmitting a downlink NAS transfer message, a class 1 message, or a class 2 message that includes the model delivery message.

As shown by reference number 1040, the UE 120 may transmit, and the AMF 510 may receive, a model delivery acknowledgement (ACK) message. The UE 120 may transmit the model delivery ACK message based at least in part on receiving the model delivery message. In some aspects, transmitting the model delivery ACK message may include transmitting an NAS message that includes the model delivery ACK message.

As shown by reference number 1045, the AMF 510 may transmit, and the MMF 515 may receive, the model delivery ACK message. The AMF 510 may transmit the model delivery ACK message to the MMF 515 based at least in part on receiving the model delivery ACK message from the UE 120.

As shown by reference number 1050, the UE 120 may transmit, and the central network entity 505 may receive, a model delivery complete message. The model delivery complete message may indicate, to the central network entity 505, that the UE 120 has received the model. In some aspects, transmitting the model delivery complete message may include transmitting an RRC message or a MAC control element (MAC-CE) that includes the model delivery complete message.

In some aspects, the NG-RAN interface may be enhanced for indicating the model identifier associated with the model that needs to be delivered to the UE 120 using a class 1 message or a class 2 message.

As indicated above, FIG. 10 is provided as an example. Other examples may differ from what is described with regard to FIG. 10.

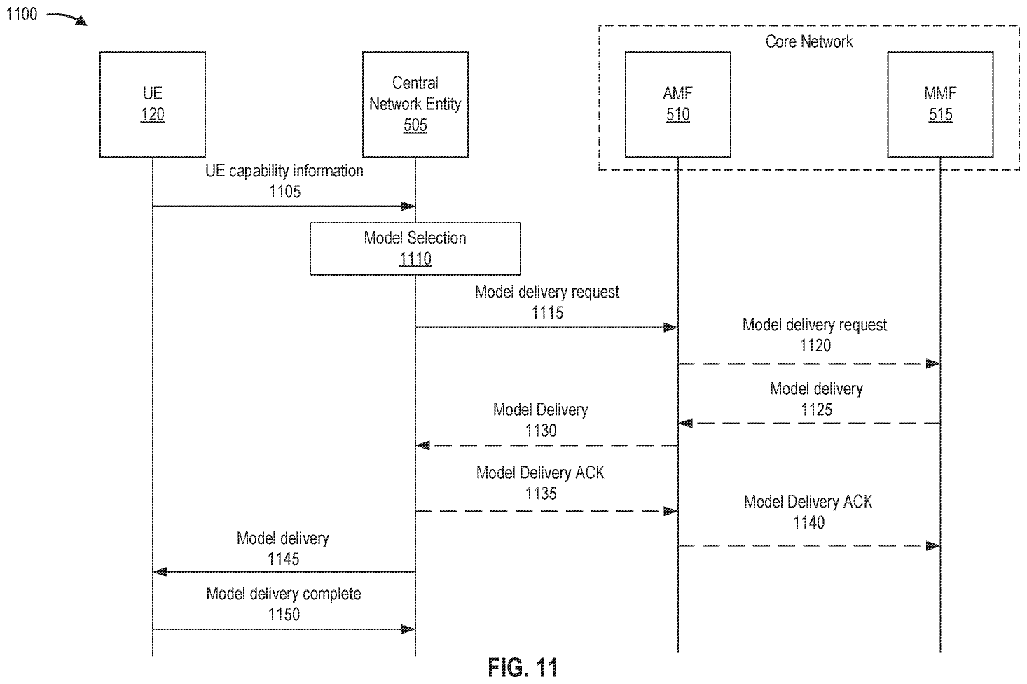

FIG. 11 is a diagram illustrating an example 1100 of a central network entity initiated model transfer from a core network, in accordance with the present disclosure.

As shown by reference number 1105, the UE 120 may transmit, and the central network entity 505 may receive, UE capability information.

As shown by reference number 1110, the central network entity 505 may perform a model selection. The central network entity 505 may select the model based at least in part on the UE capability information.

As shown by reference number 1115, the central network entity 505 may transmit, and the AMF 510 may receive, a model delivery request. The central network entity 505 may transmit the model delivery request to the AMF 510 based at least in part on selecting the model. The model delivery request may include a model identifier associated with the selected model.

As shown by reference number 1120, the AMF 510 may transmit, and the MMF 515 may receive, the model delivery request. The AMF 510 may transmit the model delivery request to the MMF 515 based at least in part on receiving the model delivery request from the central network entity 505. The model delivery request may include the model identifier associated with the selected model.

As shown by reference number 1125, the MMF 515 may transmit, and the AMF 510 may receive, a model delivery message. The MMF 515 may transmit the model delivery message based at least in part on receiving the model delivery request message. The model delivery message may include the requested model and/or may include an indication of the requested model.

As shown by reference number 1130, the AMF 510 may transmit, and the central network entity 505 may receive, the model delivery message. The AMF 510 may transmit the model delivery message to the central network entity 505 based at least in part on receiving the model delivery message from the MMF 515.

As shown by reference number 1135, the central network entity 505 may transmit, and the AMF 510 may receive, a model delivery ACK message. The central network entity 505 may transmit the model delivery ACK message based at least in part on receiving the model delivery message.

As shown by reference number 1140, the AMF 510 may transmit, and the MMF 515 may receive, the model delivery ACK message. The AMF 510 may transmit the model delivery ACK message to the MMF 515 based at least in part on receiving the model delivery ACK message from the central network entity 505.

As shown by reference number 1145, the central network entity 505 may transmit, and the UE 120 may receive, a model delivery message. The model delivery message may include the model and/or may include the indication of the model. In some aspects, transmitting the model delivery message may include transmitting an RRC message that includes the model delivery message.

As shown by reference number 1150, the UE 120 may transmit, and the central network entity 505 may receive, a model delivery complete message. The UE 120 may transmit the model delivery complete message based at least in part on receiving the model delivery message. In some aspects, transmitting the model delivery complete message may include transmitting an RRC message that includes the model delivery complete message.

In some aspects, the NG-RAN interface may be enhanced for indicating the model identifier associated with the model that is to be delivered to the UE 120 using a class 1 message or a class 2 message. The AMF 510 may send the model discovery and model delivery request message to the MMF 515. Additionally, or alternatively, the NG-RAN interface may be enhanced to deliver the model from the core network to the NG-RAN. The NG-RAN may transmit the model to the UE 120 using an RRC message after receiving the model from the core network.

As indicated above, FIG. 11 is provided as an example. Other examples may differ from what is described with regard to FIG. 11.

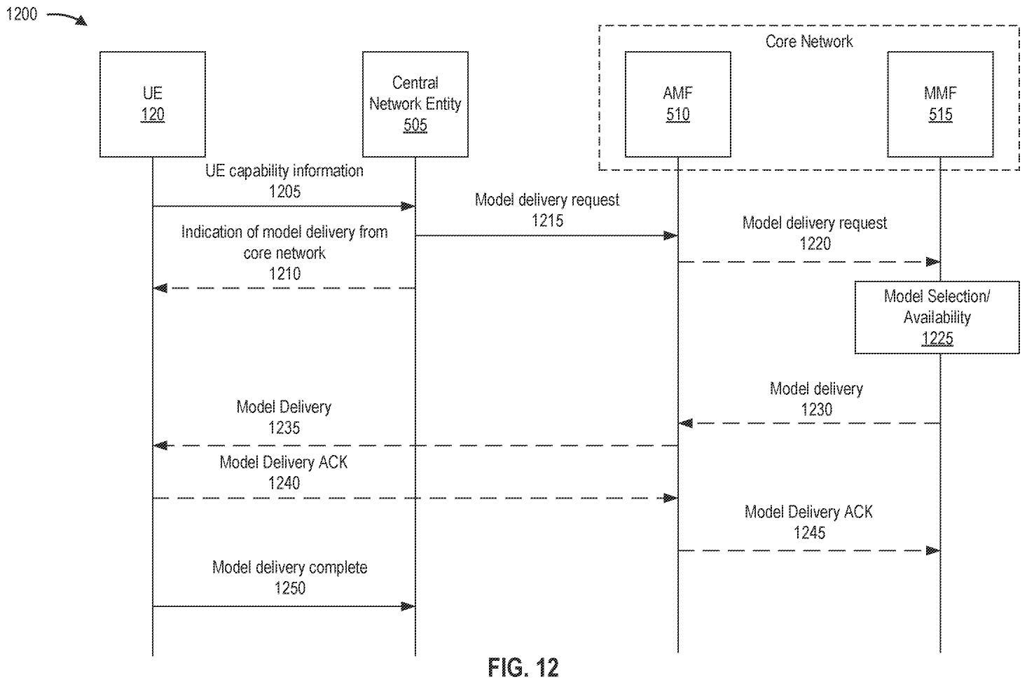

FIG. 12 is a diagram illustrating an example 1200 of model delivery based at least in part on meta information stored at a core network entity, in accordance with the present disclosure.

As shown by reference number 1205, the UE 120 may transmit, and the central network entity 505 may receive, UE capability information.

As shown by reference number 1210, the central network entity 505 may transmit, and the UE 120 may receive, an indication of model delivery from the core network. For example, the central network entity 505 may transmit an indication, to the UE 120, that the model is to be delivered to the UE 120 by the core network.

As shown by reference number 1215, the central network entity 505 may transmit, and the AMF 510 may receive, a model delivery request. The central network entity 505 may transmit the model delivery request to the AMF 510 based at least in part on receiving the UE capability information. In some aspects, the model delivery request may include UE assistance information.

As shown by reference number 1220, the AMF 510 may transmit, and the MMF 515 may receive, the model delivery request. The AMF 510 may transmit the model delivery request to the MMF 515 based at least in part on receiving the model delivery request from the central network entity 505. The model delivery request may include the UE assistance information.

As shown by reference number 1225, the MMF 515 may perform a model selection and/or determine a model availability. The MMF 515 may select the model or determine the model availability based at least in part on the model delivery request, such as based at least in part on the UE assistance information.

As shown by reference number 1230, the MMF 515 may transmit, and the AMF 510 may receive, a model delivery message. The MMF 515 may transmit the model delivery message based at least in part on selecting the model or determining the model availability. The model delivery message may include the selected model and/or may include an indication of the selected model.

As shown by reference number 1235, the AMF 510 may transmit, and the UE 120 may receive, the model delivery message. The AMF 510 may transmit the model delivery message to the UE 120 based at least in part on receiving the model delivery message from the MMF 515. In some aspects, transmitting the model delivery message may include transmitting a downlink NAS transfer message, a class 1 message, or a class 2 message that includes the model delivery message.

As shown by reference number 1240, the UE 120 may transmit, and the AMF 510 may receive, a model delivery ACK message. The UE 120 may transmit the model delivery ACK message based at least in part on receiving the model delivery message. In some aspects, transmitting the model delivery ACK message may include transmitting an NAS message that includes the model delivery ACK message.

As shown by reference number 1245, the AMF 510 may transmit, and the MMF 515 may receive, the model delivery ACK message. The AMF 510 may transmit the model delivery ACK message to the MMF 515 based at least in part on receiving the model delivery ACK message from the UE 120.

As shown by reference number 1250, the UE 120 may transmit, and the central network entity 505 may receive, a model delivery complete message. The model delivery complete message may indicate, to the central network entity 505, that the UE 120 has received (and/or downloaded) the model. In some aspects, transmitting the model delivery complete message may include transmitting an RRC message or a MAC-CE that includes the model delivery complete message.

In some aspects, the NG-RAN interface may be enhanced for providing UE assistance information for model selection at the MMF 515 using a class 1 message or a class 2 message. The assistance information may include, for example, carrier frequency information (e.g., FR1 or FR2), SCS information, BWP information, antenna tilt information, antenna pattern information, scenario information, configuration information, or a zone identifier, among other examples. A flexible protocol may be used such that the assistance information can be extended.

As indicated above, FIG. 12 is provided as an example. Other examples may differ from what is described with regard to FIG. 12.

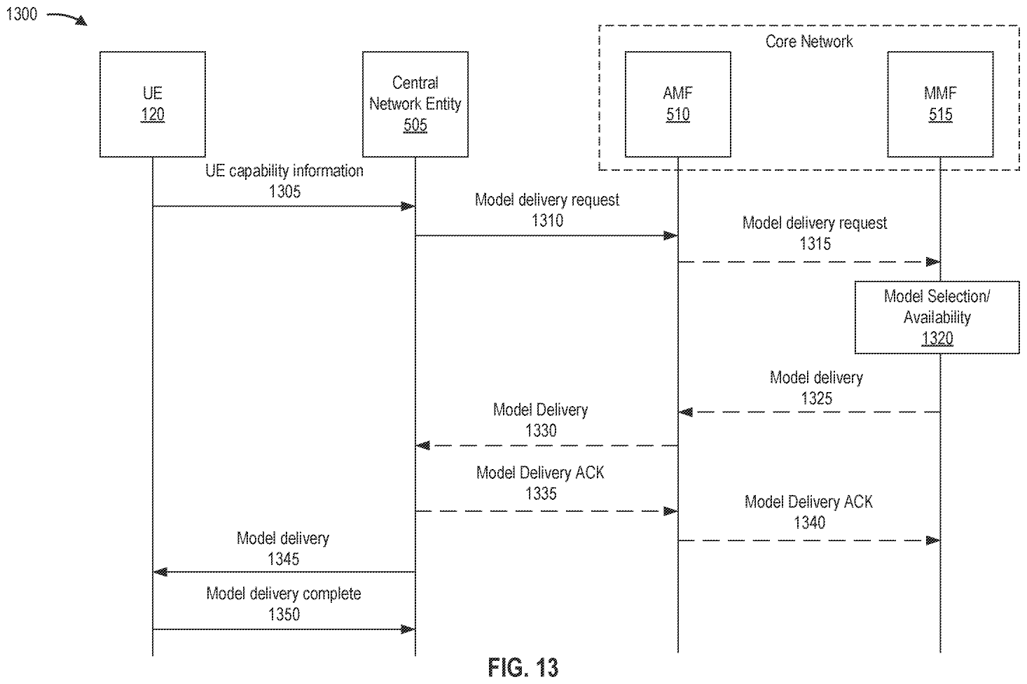

FIG. 13 is a diagram illustrating an example 1300 of a central network entity initiated model transfer from a core network, in accordance with the present disclosure.

As shown by reference number 1305, the UE 120 may transmit, and the central network entity 505 may receive, UE capability information.

As shown by reference number 1310, the central network entity 505 may transmit, and the AMF 510 may receive, a model delivery request. The central network entity 505 may transmit the model delivery request based at least in part on receiving the UE capability information. The model delivery request may include UE assistance information.

As shown by reference number 1315, the AMF 510 may transmit, and the MMF 515 may receive, the model delivery request. The AMF 510 may transmit the model delivery request to the MMF 515 based at least in part on receiving the model delivery request from the UE 120. The model delivery request may include a model identifier associated with a model.

As shown by reference number 1320, the MMF 515 may perform a model selection and/or determine a model availability. The MMF 515 may select the model or determine the model availability based at least in part on the model delivery request, such as based at least in part on the UE assistance information or the model identifier.

As shown by reference number 1325, the MMF 515 may transmit, and the AMF 510 may receive, a model delivery message. The MMF 515 may transmit the model delivery message based at least in part on selecting the model or determining the model availability. The model delivery message may include the selected model and/or may include an indication of the selected model.

As shown by reference number 1330, the AMF 510 may transmit, and the central network entity 505 may receive, the model delivery message. The AMF 510 may transmit the model delivery message to the central network entity 505 based at least in part on receiving the model delivery message from the MMF 515. The model delivery message may include the selected model and/or may include an indication of the selected model.

As shown by reference number 1335, the central network entity 505 may transmit, and the AMF 510 may receive, a model delivery ACK message. The central network entity 505 may transmit the model delivery ACK message based at least in part on receiving the model delivery message.

As shown by reference number 1340, the AMF 510 may transmit, and the MMF 515 may receive, the model delivery ACK message. The AMF 510 may transmit the model delivery ACK message to the MMF 515 based at least in part on receiving the model delivery ACK message from the central network entity 505.

As shown by reference number 1345, the central network entity 505 may transmit, and the UE 120 may receive, the model delivery message. The model delivery message may include the model and/or may include an indication of the model. In some aspects, transmitting the model delivery message may include transmitting an RRC message that includes the model delivery message.

As shown by reference number 1350, the UE 120 may transmit, and the central network entity 505 may receive, a model delivery complete message. The UE 120 may transmit the model delivery complete message based at least in part on receiving the model delivery message. In some aspects, transmitting the model delivery complete message may include transmitting an RRC message that includes the model delivery complete message.

In some aspects, an NG-AP interface may be enhanced for providing UE assistance information for model selection at the MMF 515 using a class 1 NG-AP message or a class 2 NG-AP message. The NG-AP interface may be enhanced for the delivery of the model from the core network to the NG-RAN. The NG-RAN may send the model to the UE 120 (e.g., using an RRC message) based at least in part on receiving the model from the core network.

As indicated above, FIG. 13 is provided as an example. Other examples may differ from what is described with regard to FIG. 13.

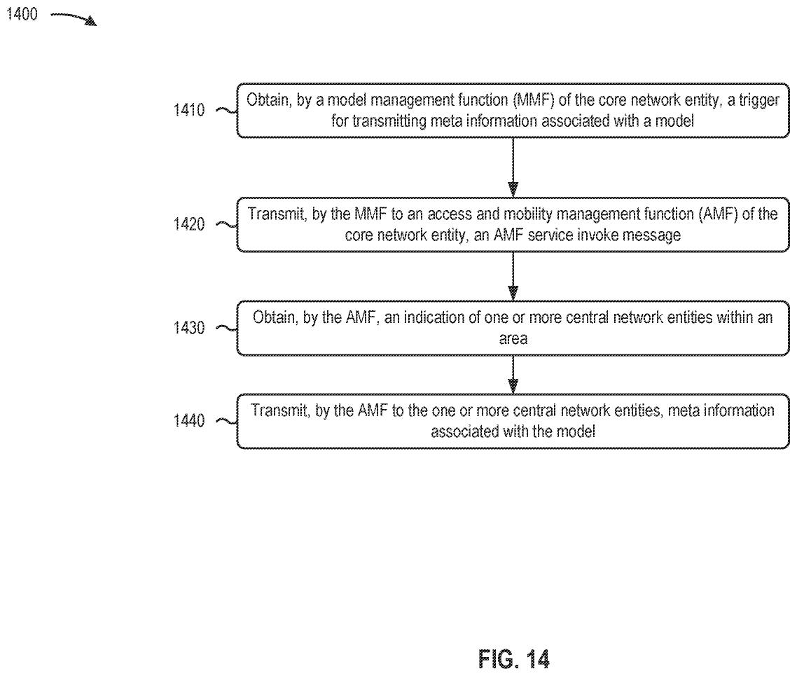

FIG. 14 shows a method 1400 for wireless communications by a core network entity, such as the AMF 510 and/or the MMF 515.

Method 1400 begins at step 1410 with obtaining, by an MMF of the core network entity, a trigger for transmitting meta information associated with a model.

Method 1400 then proceeds to step 1420 with transmitting, by the MMF to an AMF of the core network entity, an AMF service invoke message.

Method 1400 then proceeds to step 1430 with obtaining, by the AMF, an indication of one or more central network entities within an area.

Method 1400 then proceeds to step 1440 with transmitting, by the AMF to the one or more central network entities, meta information associated with the model.

In one aspect, obtaining the trigger comprises obtaining an update to the meta information associated with the model.

In one aspect, obtaining the trigger comprises receiving a request, from the one or more central network entities, for the meta information associated with the model.

In one aspect, transmitting the meta information associated with the model comprises transmitting at least one of a model identifier associated with the model or a model identifier list that identifies the model.

In one aspect, obtaining the indication of the one or more central network entities within the area comprises obtaining an indication of a plurality of central network entities within the area; and the method further comprises selecting, by the AMF, a central network entity of the plurality of central network entities within the area, wherein transmitting the meta information associated with the model comprises transmitting, by the AMF to the selected central network entity of the plurality of central network entities, the meta information associated with the model.

In one aspect, transmitting the AMF service invoke message comprises transmitting, by the MMF to the AMF, a meta information update indication that includes at least one of a model identifier associated with the model, a model identifier list that identifies the model, the meta information, or an indication of the area.

In one aspect, the indication of the area is an indication of a service area or an indication of a geographic area.

In one aspect, method 1400 further includes receiving, by at least one of the MMF or the AMF, a meta information update request, and transmitting, by at least one of the MMF or the AMF, a meta information update response.

In one aspect, the meta information update request includes a model identifier associated with the model or a model identifier list that identifies the model, and the meta information update response includes meta information associated with at least one of the model identifier associated with the model or the model identifier list that identifies the model.

In one aspect, the meta information indicates at least one of a scenario associated with the model, a configuration associated with the model, a setting associated with the model, a zone identifier associated with the model, an SCS associated with an operation of the model, an antenna configuration associated with an operation of the model, carrier information associated with an operation of the model, or bandwidth part information associated with an operation of the model.

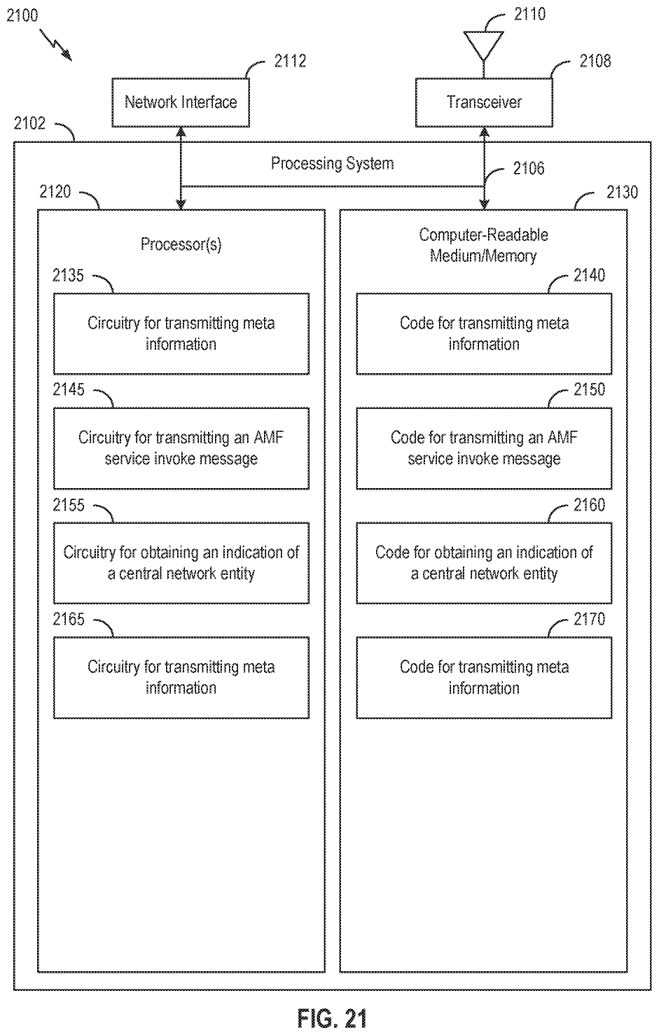

In one aspect, method 1400, or any aspect related to it, may be performed by an apparatus, such as communications device 2100 of FIG. 21, which includes various components operable, configured, or adapted to perform the method 1400. Communications device 2100 is described below in further detail.

Note that FIG. 14 is just one example of a method, and other methods including fewer, additional, or alternative steps are possible consistent with this disclosure.

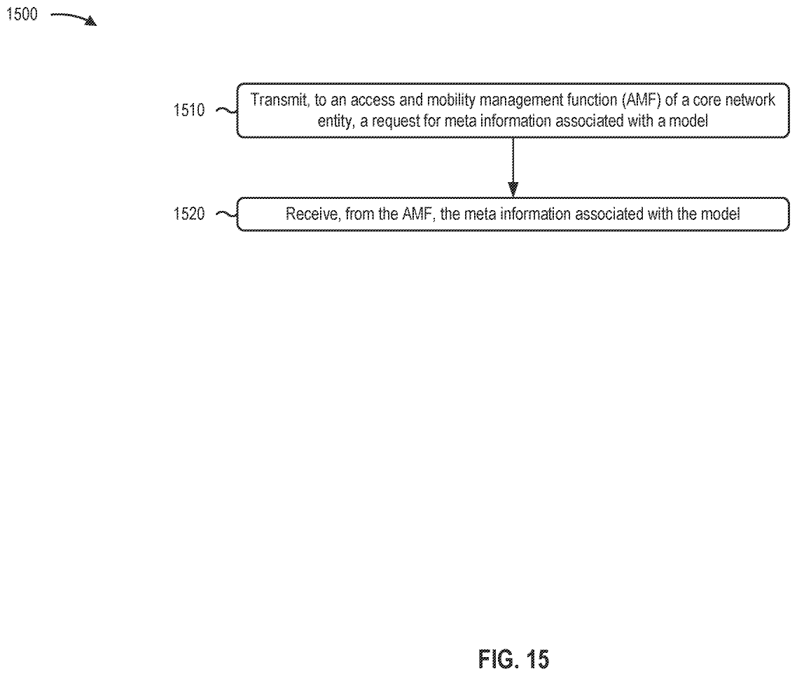

FIG. 15 shows a method 1500 for wireless communications by a central network entity, such as central network entity 505.

Method 1500 begins at step 1510 with transmitting, to an AMF of a core network entity, a request for meta information associated with a model.

Method 1500 then proceeds to step 1520 with receiving, from the AMF, the meta information associated with the model.

In one aspect, the request for the meta information associated with the model includes at least one of a model identifier associated with the model or a model identifier list that identifies the model.

In one aspect, transmitting the request for the meta information associated with the model comprises transmitting a request for updated meta information associated with the model, and receiving the meta information associated with the model comprises receiving updated meta information associated with the model.

In one aspect, the meta information indicates at least one of a scenario associated with the model, a configuration associated with the model, a setting associated with the model, a zone identifier associated with the model, an SCS associated with an operation of the model, an antenna configuration associated with an operation of the model, carrier information associated with an operation of the model, or bandwidth part information associated with an operation of the model.

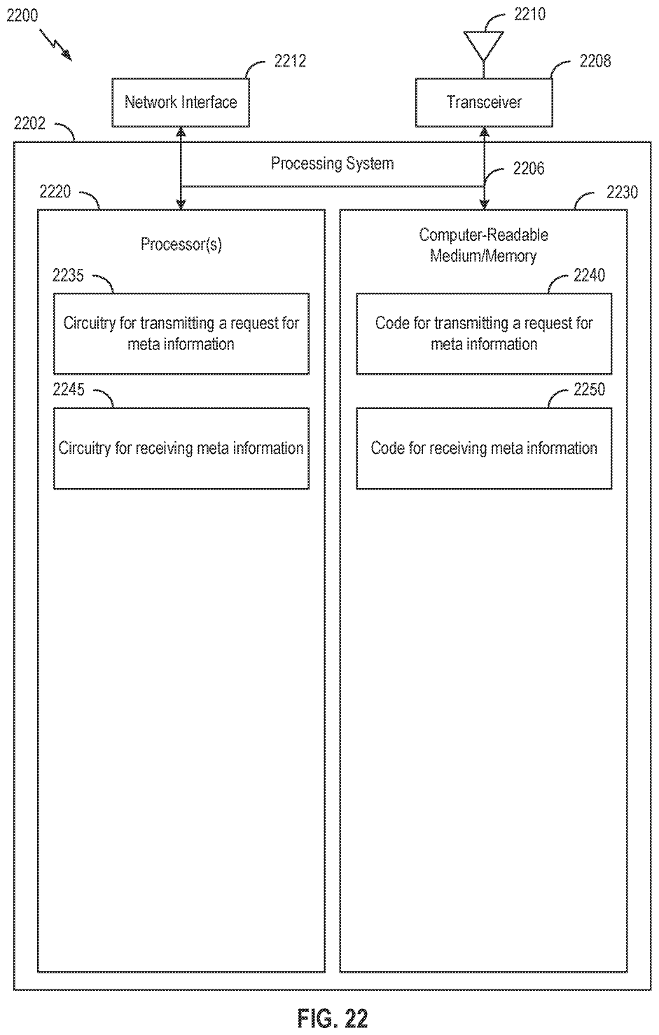

In one aspect, method 1500, or any aspect related to it, may be performed by an apparatus, such as communications device 2200 of FIG. 22, which includes various components operable, configured, or adapted to perform the method 1500. Communications device 2200 is described below in further detail.

Note that FIG. 15 is just one example of a method, and other methods including fewer, additional, or alternative steps are possible consistent with this disclosure.

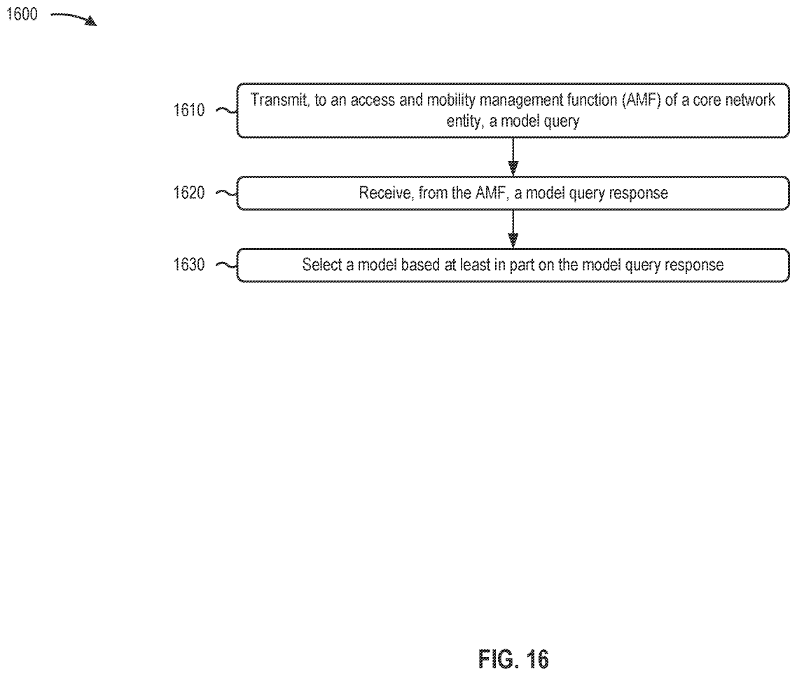

FIG. 16 shows a method 1600 for wireless communications by a UE, such as UE 120.

Method 1600 begins at step 1610 with transmitting, to an AMF of a core network entity, a model query.

Method 1600 then proceeds to step 1620 with receiving, from the AMF, a model query response.

Method 1600 then proceeds to step 1630 with selecting a model based at least in part on the model query response.

In one aspect, method 1600 further includes transmitting, to a central network entity, UE capability information associated with the model.

In one aspect, the model query includes at least one of UE capability information or UE area information.

In one aspect, the UE area information is based at least in part on a registration area, wherein the registration area is based at least in part on a tracking area identity or a tracking area code.

In one aspect, the model query response includes at least one of meta information associated with the model or a model identifier associated with the model.

In one aspect, the model query is included in an uplink NAS transport message, a class 1 NAS message, a class 2 NAS message, a class 1 message, or a class 2 message.

In one aspect, method 1600 further includes transmitting, to the AMF, MMF information.

In one aspect, the model query response is included in a registration accept message, a downlink NAS transport message, a class 1 NAS message, a class 2 NAS message, a class 1 message, or a class 2 message.

In one aspect, selecting the model based at least in part on the model query response comprises selecting the model based at least in part on meta information included in the model query response.

In one aspect, method 1600 further includes transmitting, to a central network entity, UE capability information; receiving, from the central network entity, a model download request that includes an indication of a model; and transmitting, to the central network entity, a model download complete message.

In one aspect, the model download request includes a model identifier or UE assistance information for supporting model selection at an MMF of the core network entity.

In one aspect, the UE assistance information includes at least one of a carrier frequency indication, a sub-carrier spacing indication, a bandwidth part indication, an antenna tilt indication, an antenna pattern indication, or a scenario, configuration, or zone identifier.

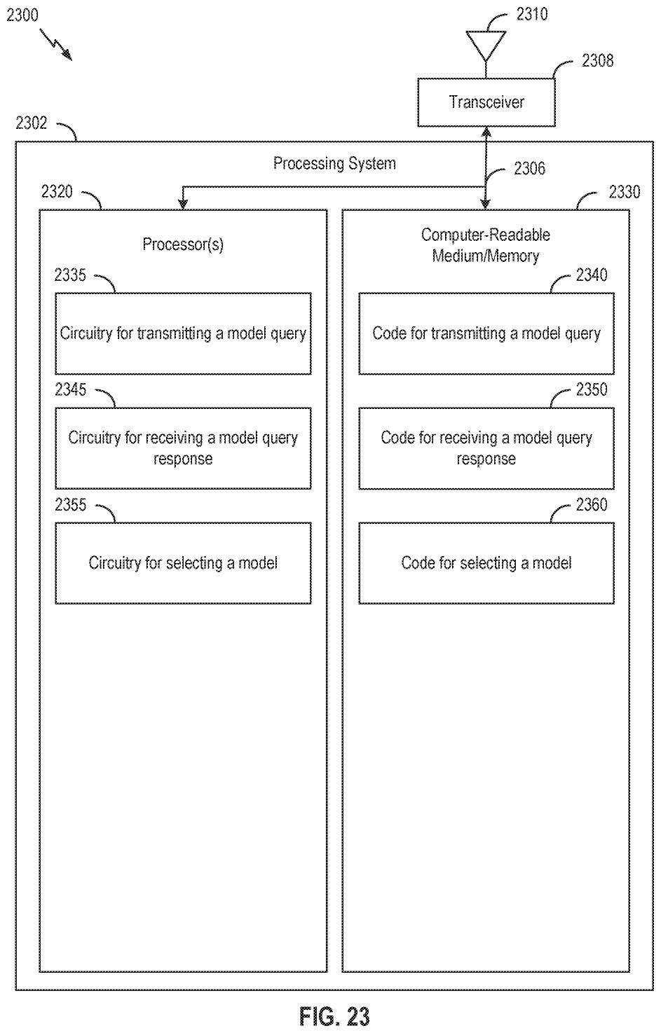

In one aspect, method 1600, or any aspect related to it, may be performed by an apparatus, such as communications device 2300 of FIG. 23, which includes various components operable, configured, or adapted to perform the method 1600. Communications device 2300 is described below in further detail.

Note that FIG. 16 is just one example of a method, and other methods including fewer, additional, or alternative steps are possible consistent with this disclosure.

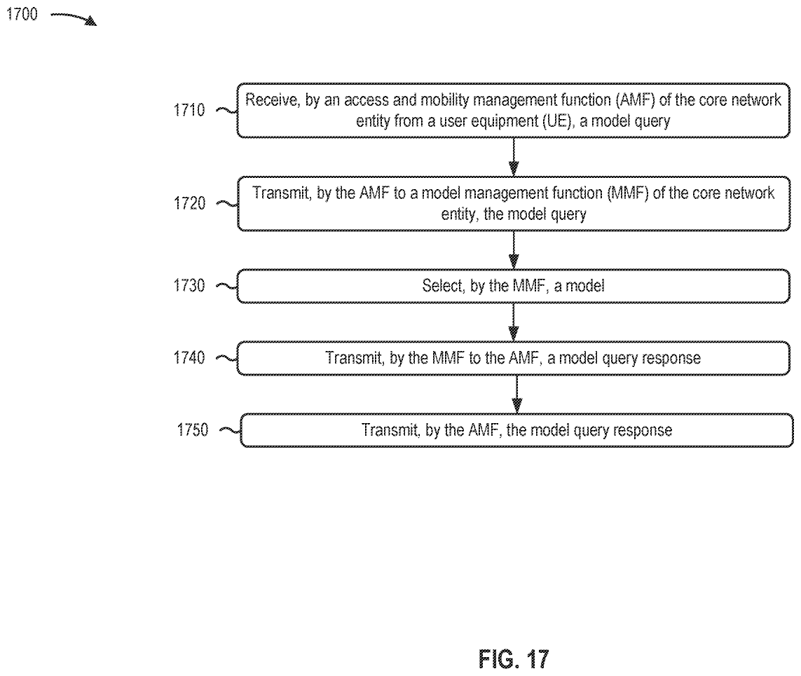

FIG. 17 shows a method 1700 for wireless communications by a core network entity, such as the AMF 510 and/or the MMF 515.

Method 1700 begins at step 1710 with receiving, by an AMF of the core network entity from a UE, a model query.

Method 1700 then proceeds to step 1720 with transmitting, by the AMF to an MMF of the core network entity, the model query.

Method 1700 then proceeds to step 1730 with selecting, by the MMF, a model.

Method 1700 then proceeds to step 1740 with transmitting, by the MMF to the AMF, a model query response.

Method 1700 then proceeds to step 1750 with transmitting, by the AMF, the model query response.

In one aspect, the model query includes at least one of UE capability information or UE area information.

In one aspect, the UE area information is based at least in part on a registration area, wherein the registration area is based at least in part on a tracking area identity or a tracking area code.

In one aspect, the model query response includes at least one of meta information associated with the model or a model identifier associated with the model.

In one aspect, receiving the model query comprises receiving, by the AMF from the UE, an uplink NAS transport message, a class 1 NAS message, a class 2 NAS message, a class 1 message, or a class 2 message.

In one aspect, transmitting the model query response comprises transmitting, from the AMF to the UE, a registration accept message, a downlink NAS transport message, a class 1 NAS message, a class 2 NAS message, a class 1 message, or a class 2 message.

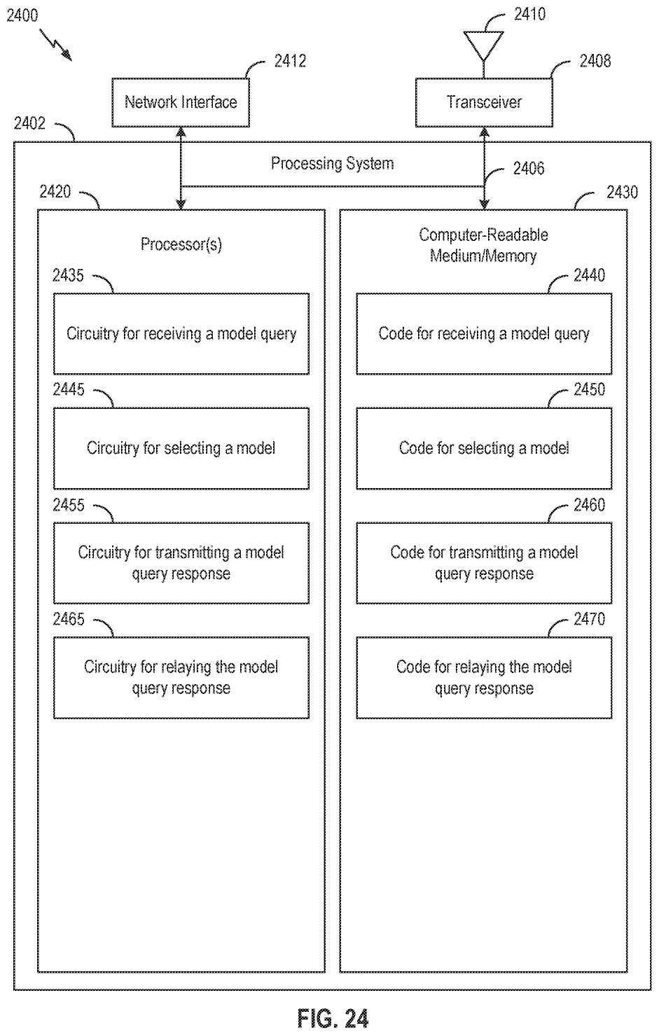

In one aspect, method 1700, or any aspect related to it, may be performed by an apparatus, such as communications device 2400 of FIG. 24, which includes various components operable, configured, or adapted to perform the method 1700. Communications device 2400 is described below in further detail.

Note that FIG. 17 is just one example of a method, and other methods including fewer, additional, or alternative steps are possible consistent with this disclosure.

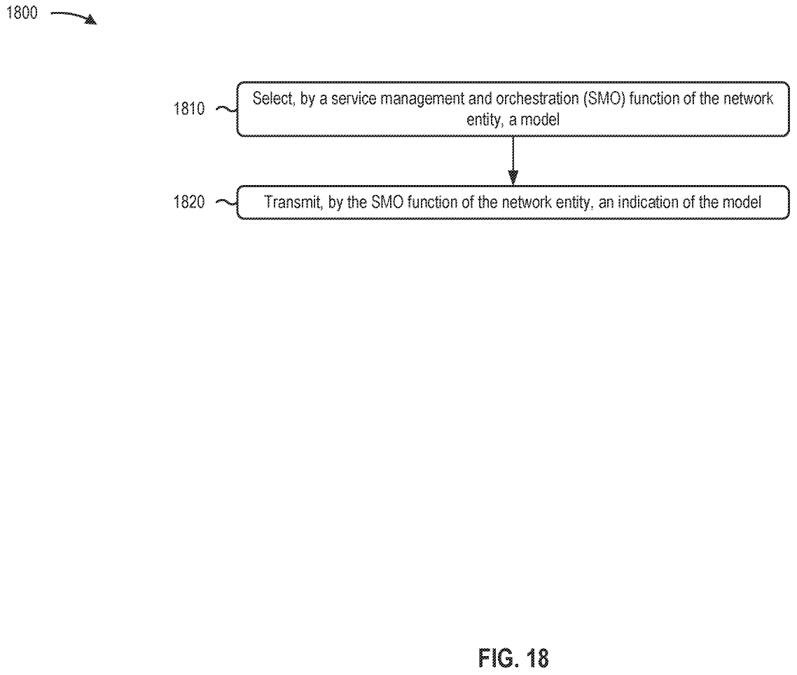

FIG. 18 shows a method 1800 for wireless communications by a network entity, such as the OAM/SMO 805.

Method 1800 begins at step 1810 with selecting, by a service management and orchestration (SMO) function of the network entity, a model.

Method 1800 then proceeds to step 1820 with transmitting, by the SMO function of the network entity, an indication of the model.

In one aspect, method 1800 further includes receiving, from a central network entity, a model delivery request message, wherein transmitting the indication of the model comprises transmitting, by the SMO function of the network entity to the central network entity, the indication of the model.

In one aspect, the model delivery request message includes a model identifier associated with the model or UE assistance information.

In one aspect, receiving the model delivery request message comprises receiving a radio access network intelligent controller indication message, a class 1 message, or a class 2 message.

In one aspect, method 1800 further includes receiving, from a central network entity, UE capability information; determining to initiate an AI or a ML process; and transmitting information associated with the AI or ML process.

In one aspect, method 1800 further includes receiving UE context information or radio access network information from the central network entity.

In one aspect, method 1800 further includes requesting UE assistance information from the central network entity.

In one aspect, transmitting the information associated with the AI or ML process comprises transmitting the information associated with the AI or ML process to the central network entity.

In one aspect, transmitting the information associated with the AI or ML process comprises transmitting the information associated with the AI or ML process to a UE.

In one aspect, the information associated with the AI or ML process is associated with a signaling-or-management-based procedure for initializing the AI or ML process or for providing the model to a UE.

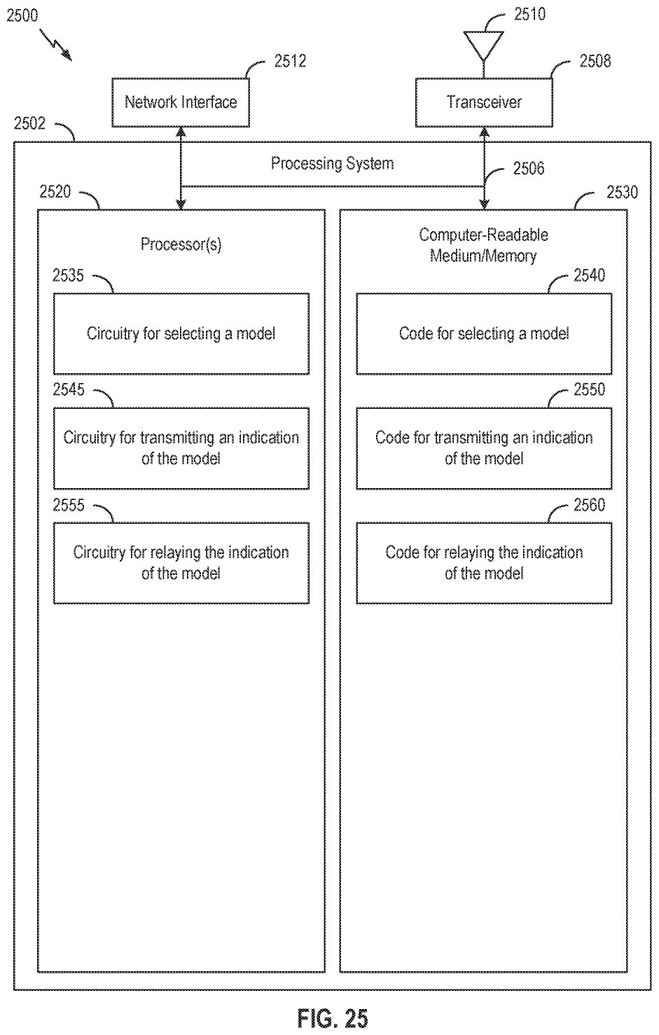

In one aspect, method 1800, or any aspect related to it, may be performed by an apparatus, such as communications device 2500 of FIG. 25, which includes various components operable, configured, or adapted to perform the method 1800. Communications device 2500 is described below in further detail.

Note that FIG. 18 is just one example of a method, and other methods including fewer, additional, or alternative steps are possible consistent with this disclosure.

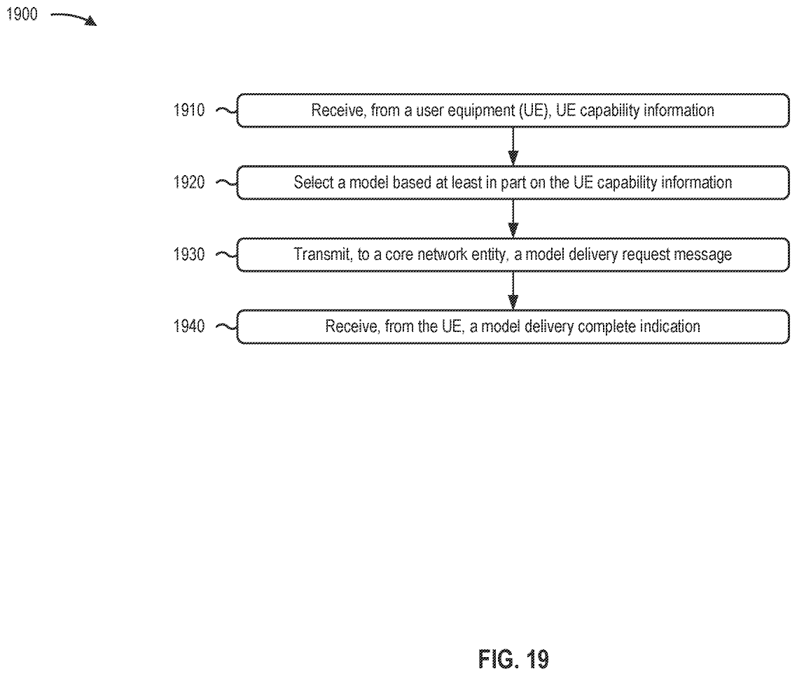

FIG. 19 shows a method 1900 for wireless communications by a central network entity, such as central network entity 505.

Method 1900 begins at step 1910 with receiving, from a UE, UE capability information.

Method 1900 then proceeds to step 1920 with selecting a model based at least in part on the UE capability information.

Method 1900 then proceeds to step 1930 with transmitting, to a core network entity, a model delivery request message.

Method 1900 then proceeds to step 1940 with receiving, from the UE, a model delivery complete indication.

In one aspect, the model delivery request message includes an indication of a model identifier associated with the model.

In one aspect, transmitting the model delivery request message comprises transmitting, to the core network entity, a class 1 message or a class 2 message that includes the model delivery request message.

In one aspect, transmitting the model delivery request message comprises transmitting, to an access and mobility management function, the model delivery request message.

In one aspect, method 1900 further includes transmitting, to the UE, a radio resource control message or a medium access control message that indicates that the model is to be received from the core network entity.

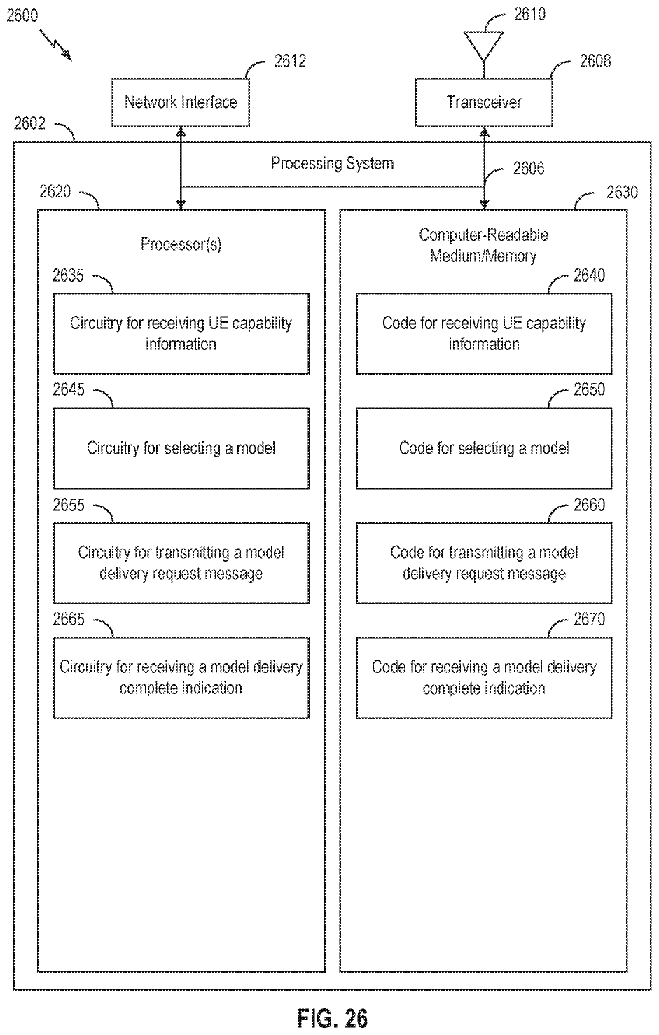

In one aspect, method 1900, or any aspect related to it, may be performed by an apparatus, such as communications device 2600 of FIG. 26, which includes various components operable, configured, or adapted to perform the method 1900. Communications device 2600 is described below in further detail.

Note that FIG. 19 is just one example of a method, and other methods including fewer, additional, or alternative steps are possible consistent with this disclosure.

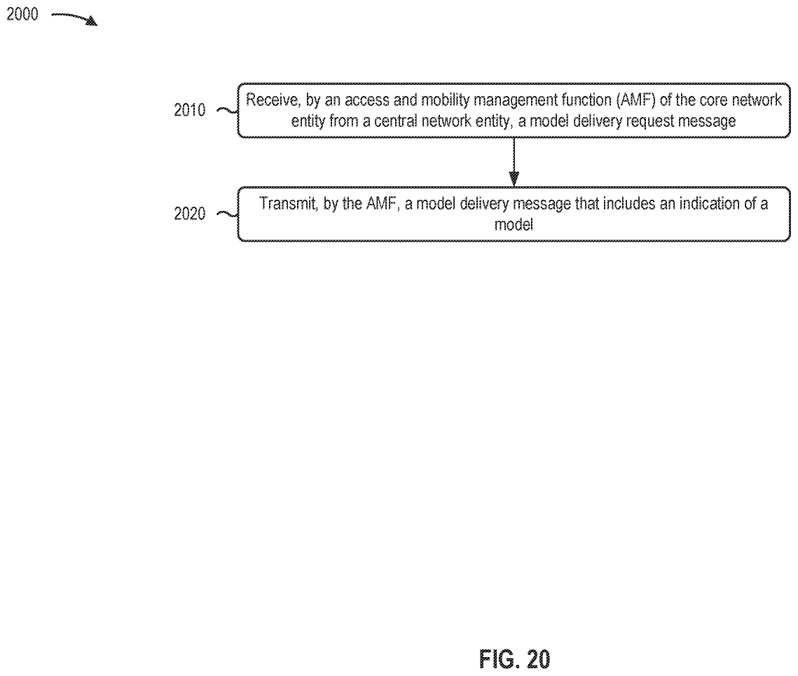

FIG. 20 shows a method 2000 for wireless communications by a UE, such as UE 120.

Method 2000 begins at step 2010 with receiving, by an AMF of the core network entity from a central network entity, a model delivery request message.

Method 2000 then proceeds to step 2020 with transmitting, by the AMF, a model delivery message that includes an indication of a model.

In one aspect, the model delivery request message includes an indication of a model identifier associated with the model.

In one aspect, method 2000 further includes transmitting, by the AMF to an MMF of the core network entity, the model delivery request message; and receiving, by the AMF from the MMF, the model delivery message that includes the indication of the model.

In one aspect, transmitting the model delivery message comprises transmitting, by the AMF to a UE, a downlink NAS message, a class 1 message, or a class 2 message that includes the model delivery message.

In one aspect, method 2000 further includes receiving, by the AMF from the UE, a model delivery acknowledgement message.

In one aspect, method 2000 further includes transmitting, by the AMF to a mobility management function, the model delivery acknowledgement message.

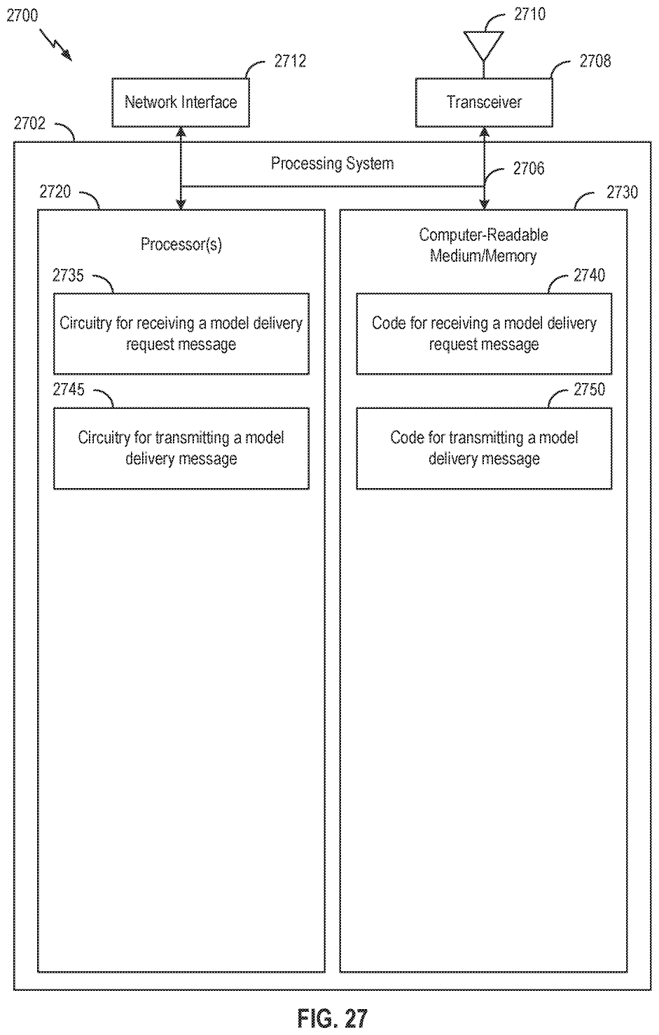

In one aspect, method 2000, or any aspect related to it, may be performed by an apparatus, such as communications device 2700 of FIG. 27, which includes various components operable, configured, or adapted to perform the method 2000. Communications device 2700 is described below in further detail.

Note that FIG. 20 is just one example of a method, and other methods including fewer, additional, or alternative steps are possible consistent with this disclosure.

FIG. 21 is a diagram illustrating an example of an implementation of code and circuitry for a communications device 2100, in accordance with the present disclosure. The communications device 2100 may be a core network entity (such as BS 110 or a disaggregated base station as described with regard to FIG. 3), or a core network entity may include the communications device 2100.

The communications device 2100 includes a processing system 2102 coupled to a transceiver 2108 (e.g., a transmitter and/or a receiver). The transceiver 2108 is configured to transmit and receive signals for the communications device 2100 via an antenna 2110, such as the various signals as described herein. The network interface 2112 is configured to obtain and send signals for the communications device 2100 via communications link(s), such as a backhaul link, midhaul link, and/or fronthaul link as described herein, such as with respect to FIG. 3. The processing system 2102 may be configured to perform processing functions for the communications device 2100, including processing signals received and/or to be transmitted by the communications device 2100.

The processing system 2102 includes one or more processors 2120. In various aspects, the one or more processors 2120 may be representative of one or more of receive processor 238, transmit processor 220, TX MIMO processor 230, and/or controller/processor 240, as described with respect to FIG. 2. The one or more processors 2120 are coupled to a computer-readable medium/memory 2130 via a bus 2106. In various aspects, the computer-readable medium/memory 2130 may be representative of memory 242, as described with respect to FIG. 2. In certain aspects, the computer-readable medium/memory 2130 is configured to store instructions (e.g., computer-executable code, processor-executable code) that when executed by the one or more processors 2120, cause the one or more processors 2120 to perform the method 1400 described with respect to FIG. 14, or any aspect related to it. Note that reference to a processor performing a function of communications device 2100 may include one or more processors performing that function of communications device 2100.

As shown in FIG. 21, the communications device 2100 may include circuitry for obtaining, by an MMF of the core network entity, a trigger for transmitting meta information associated with a model (circuitry 2135).

As shown in FIG. 21, the communications device 2100 may include, stored in computer-readable medium/memory 2130, code for obtaining, by an MMF of the core network entity, a trigger for transmitting meta information associated with a model (code 2140).

As shown in FIG. 21, the communications device 2100 may include circuitry for transmitting, by the MMF to an AMF of the core network entity, an AMF service invoke message (circuitry 2145).

As shown in FIG. 21, the communications device 2100 may include, stored in computer-readable medium/memory 2130, code for transmitting, by the MMF to an AMF of the core network entity, an AMF service invoke message (code 2150).

As shown in FIG. 21, the communications device 2100 may include circuitry for obtaining, by the AMF, an indication of one or more central network entities within an area (circuitry 2155).

As shown in FIG. 21, the communications device 2100 may include, stored in computer-readable medium/memory 2130, code for obtaining, by the AMF, an indication of one or more central network entities within an area (code 2160).

As shown in FIG. 21, the communications device 2100 may include circuitry for transmitting, by the AMF to the one or more central network entities, meta information associated with the model (circuitry 2165).

As shown in FIG. 21, the communications device 2100 may include, stored in computer-readable medium/memory 2130, code for transmitting, by the AMF to the one or more central network entities, meta information associated with the model (code 2170).

Various components of the communications device 2100 may provide means for performing the method 1400 described with respect to FIG. 14, or any aspect related to it. For example, means for transmitting, sending, or outputting for transmission may include the transceiver(s) 232 and/or antenna(s) 234 of the BS 110 and/or transceiver 2108 and antenna 2110 of the communications device 2100 in FIG. 21. Means for receiving or obtaining may include the transceiver(s) 232 and/or antenna(s) 234 of the BS 110 and/or transceiver 2108 and antenna 2110 of the communications device 2100 in FIG. 21.

FIG. 21 is provided as an example. Other examples may differ from what is described in connection with FIG. 21.

FIG. 22 is a diagram illustrating an example of an implementation of code and circuitry for a communications device 2200, in accordance with the present disclosure. The communications device 2200 may be a central network entity (such as BS 110 or a disaggregated base station as described with regard to FIG. 3), or a central network entity may include the communications device 2200.

The communications device 2200 includes a processing system 2202 coupled to a transceiver 2208 (e.g., a transmitter and/or a receiver). The transceiver 2208 is configured to transmit and receive signals for the communications device 2200 via an antenna 2210, such as the various signals as described herein. The network interface 2212 is configured to obtain and send signals for the communications device 2200 via communications link(s), such as a backhaul link, midhaul link, and/or fronthaul link as described herein, such as with respect to FIG. 3. The processing system 2202 may be configured to perform processing functions for the communications device 2200, including processing signals received and/or to be transmitted by the communications device 2200.

The processing system 2202 includes one or more processors 2220. In various aspects, the one or more processors 2220 may be representative of one or more of receive processor 238, transmit processor 220, TX MIMO processor 230, and/or controller/processor 240, as described with respect to FIG. 2. The one or more processors 2220 are coupled to a computer-readable medium/memory 2230 via a bus 2206. In various aspects, the computer-readable medium/memory 2230 may be representative of memory 242, as described with respect to FIG. 2. In certain aspects, the computer-readable medium/memory 2230 is configured to store instructions (e.g., computer-executable code, processor-executable code) that when executed by the one or more processors 2220, cause the one or more processors 2220 to perform the method 1500 described with respect to FIG. 15, or any aspect related to it. Note that reference to a processor performing a function of communications device 2200 may include one or more processors performing that function of communications device 2200.

As shown in FIG. 22, the communications device 2200 may include circuitry for transmitting, to an AMF of a core network entity, a request for meta information associated with a model (circuitry 2235).

As shown in FIG. 22, the communications device 2200 may include, stored in computer-readable medium/memory 2230, code for transmitting, to an AMF of a core network entity, a request for meta information associated with a model (code 2240).

As shown in FIG. 22, the communications device 2200 may include circuitry for receiving, from the AMF, the meta information associated with the model (circuitry 2245).

As shown in FIG. 22, the communications device 2200 may include, stored in computer-readable medium/memory 2230, code for receiving, from the AMF, the meta information associated with the model (code 2250).

Various components of the communications device 2200 may provide means for performing the method 1500 described with respect to FIG. 15, or any aspect related to it. For example, means for transmitting, sending, or outputting for transmission may include the transceiver(s) 232 and/or antenna(s) 234 of the BS 110 and/or transceiver 2208 and antenna 2210 of the communications device 2200 in FIG. 22. Means for receiving or obtaining may include the transceiver(s) 232 and/or antenna(s) 234 of the BS 110 and/or transceiver 2208 and antenna 2210 of the communications device 2200 in FIG. 22.

FIG. 22 is provided as an example. Other examples may differ from what is described in connection with FIG. 22.

FIG. 23 is a diagram illustrating an example of an implementation of code and circuitry for a communications device 2300, in accordance with the present disclosure. The communications device 2300 may be a UE, or a UE may include the communications device 2300.

The communications device 2300 includes a processing system 2302 coupled to a transceiver 2308 (e.g., a transmitter and/or a receiver). The transceiver 2308 is configured to transmit and receive signals for the communications device 2300 via an antenna 2310, such as the various signals as described herein. The processing system 2302 may be configured to perform processing functions for the communications device 2300, including processing signals received and/or to be transmitted by the communications device 2300.

The processing system 2302 includes one or more processors 2320. In various aspects, the one or more processors 2320 may be representative of one or more of receive processor 258, transmit processor 264, TX MIMO processor 266, and/or controller/processor 280, as described with respect to FIG. 2. The one or more processors 2320 are coupled to a computer-readable medium/memory 2330 via a bus 2306. In various aspects, the computer-readable medium/memory 2330 may be representative of memory 282, as described with respect to FIG. 2. In certain aspects, the computer-readable medium/memory 2330 is configured to store instructions (e.g., computer-executable code, processor-executable code) that when executed by the one or more processors 2320, cause the one or more processors 2320 to perform the method 1600 described with respect to FIG. 16, or any aspect related to it. Note that reference to a processor performing a function of communications device 2300 may include one or more processors performing that function of communications device 2300.

As shown in FIG. 23, the communications device 2300 may include circuitry for transmitting, to an AMF of a core network entity, a model query (circuitry 2335).

As shown in FIG. 23, the communications device 2300 may include, stored in computer-readable medium/memory 2330, code for transmitting, to an AMF of a core network entity, a model query (code 2340).

As shown in FIG. 23, the communications device 2300 may include circuitry for receiving, from the AMF, a model query response (circuitry 2345).

As shown in FIG. 23, the communications device 2300 may include, stored in computer-readable medium/memory 2330, code for receiving, from the AMF, a model query response (code 2350).

As shown in FIG. 23, the communications device 2300 may include circuitry for selecting a model based at least in part on the model query response (circuitry 2355).

As shown in FIG. 23, the communications device 2300 may include, stored in computer-readable medium/memory 2330, code for selecting a model based at least in part on the model query response (code 2360).

Various components of the communications device 2300 may provide means for performing the method 1600 described with respect to FIG. 16, or any aspect related to it. For example, means for transmitting, sending, or outputting for transmission may include the transceiver(s) 254 and/or antenna(s) 252 of the UE 120 and/or transceiver 2308 and antenna 2310 of the communications device 2300 in FIG. 23. Means for receiving or obtaining may include the transceiver(s) 254 and/or antenna(s) 252 of the UE 120 and/or transceiver 2308 and antenna 2310 of the communications device 2300 in FIG. 23.

FIG. 23 is provided as an example. Other examples may differ from what is described in connection with FIG. 23.

FIG. 24 is a diagram illustrating an example of an implementation of code and circuitry for a communications device 2400, in accordance with the present disclosure. The communications device 2400 may be a core network entity (such as BS 110 or a disaggregated base station as described with regard to FIG. 3), or a core network entity may include the communications device 2400.

The communications device 2400 includes a processing system 2402 coupled to a transceiver 2408 (e.g., a transmitter and/or a receiver). The transceiver 2408 is configured to transmit and receive signals for the communications device 2400 via an antenna 2410, such as the various signals as described herein. The network interface 2412 is configured to obtain and send signals for the communications device 2400 via communications link(s), such as a backhaul link, midhaul link, and/or fronthaul link as described herein, such as with respect to FIG. 3. The processing system 2402 may be configured to perform processing functions for the communications device 2400, including processing signals received and/or to be transmitted by the communications device 2400.

The processing system 2402 includes one or more processors 2420. In various aspects, the one or more processors 2420 may be representative of one or more of receive processor 238, transmit processor 220, TX MIMO processor 230, and/or controller/processor 240, as described with respect to FIG. 2. The one or more processors 2420 are coupled to a computer-readable medium/memory 2430 via a bus 2406. In various aspects, the computer-readable medium/memory 2430 may be representative of memory 242, as described with respect to FIG. 2. In certain aspects, the computer-readable medium/memory 2430 is configured to store instructions (e.g., computer-executable code, processor-executable code) that when executed by the one or more processors 2420, cause the one or more processors 2420 to perform the method 1700 described with respect to FIG. 17, or any aspect related to it. Note that reference to a processor performing a function of communications device 2400 may include one or more processors performing that function of communications device 2400.

As shown in FIG. 24, the communications device 2400 may include circuitry for receiving, by an AMF of the core network entity from a UE, a model query (circuitry 2435).

As shown in FIG. 24, the communications device 2400 may include, stored in computer-readable medium/memory 2430, code for receiving, by an AMF of the core network entity from a UE, a model query (code 2440).

As shown in FIG. 24, the communications device 2400 may include circuitry for selecting, by the MMF, a model (circuitry 2445).

As shown in FIG. 24, the communications device 2400 may include, stored in computer-readable medium/memory 2430, code for selecting, by the MMF, a model (code 2450).

As shown in FIG. 24, the communications device 2400 may include circuitry for transmitting, by the MMF to the AMF, a model query response (circuitry 2455).

As shown in FIG. 24, the communications device 2400 may include, stored in computer-readable medium/memory 2430, code for transmitting, by the MMF to the AMF, a model query response (code 2460).

As shown in FIG. 24, the communications device 2400 may include circuitry for transmitting, by the AMF, the model query response (circuitry 2465).

As shown in FIG. 24, the communications device 2400 may include, stored in computer-readable medium/memory 2430, code for transmitting, by the AMF, the model query response (code 2470).

Various components of the communications device 2400 may provide means for performing the method 1700 described with respect to FIG. 17, or any aspect related to it. For example, means for transmitting, sending, or outputting for transmission may include the transceiver(s) 232 and/or antenna(s) 234 of the BS 110 and/or transceiver 2408 and antenna 2410 of the communications device 2400 in FIG. 24. Means for receiving or obtaining may include the transceiver(s) 232 and/or antenna(s) 234 of the BS 110 and/or transceiver 2408 and antenna 2410 of the communications device 2400 in FIG. 24.

FIG. 24 is provided as an example. Other examples may differ from what is described in connection with FIG. 24.

FIG. 25 is a diagram illustrating an example of an implementation of code and circuitry for a communications device 2500, in accordance with the present disclosure. The communications device 2500 may be a network entity (such as BS 110 or a disaggregated base station as described with regard to FIG. 3), or a network entity may include the communications device 2500.

The communications device 2500 includes a processing system 2502 coupled to a transceiver 2508 (e.g., a transmitter and/or a receiver). The transceiver 2508 is configured to transmit and receive signals for the communications device 2500 via an antenna 2510, such as the various signals as described herein. The network interface 2512 is configured to obtain and send signals for the communications device 2500 via communications link(s), such as a backhaul link, midhaul link, and/or fronthaul link as described herein, such as with respect to FIG. 3. The processing system 2502 may be configured to perform processing functions for the communications device 2500, including processing signals received and/or to be transmitted by the communications device 2500.

The processing system 2502 includes one or more processors 2520. In various aspects, the one or more processors 2520 may be representative of one or more of receive processor 238, transmit processor 220, TX MIMO processor 230, and/or controller/processor 240, as described with respect to FIG. 2. The one or more processors 2520 are coupled to a computer-readable medium/memory 2530 via a bus 2506. In various aspects, the computer-readable medium/memory 2530 may be representative of memory 242, as described with respect to FIG. 2. In certain aspects, the computer-readable medium/memory 2530 is configured to store instructions (e.g., computer-executable code, processor-executable code) that when executed by the one or more processors 2520, cause the one or more processors 2520 to perform the method 1800 described with respect to FIG. 18, or any aspect related to it. Note that reference to a processor performing a function of communications device 2500 may include one or more processors performing that function of communications device 2500.

As shown in FIG. 25, the communications device 2500 may include circuitry for selecting, by an SMO function of the network entity, a model (circuitry 2535).

As shown in FIG. 25, the communications device 2500 may include, stored in computer-readable medium/memory 2530, code for selecting, by an SMO function of the network entity, a model (code 2540).

As shown in FIG. 25, the communications device 2500 may include circuitry for transmitting, by the SMO function of the network entity, an indication of the model (circuitry 2545).

As shown in FIG. 25, the communications device 2500 may include, stored in computer-readable medium/memory 2530, code for transmitting, by the SMO function of the network entity, an indication of the model (code 2550).

As shown in FIG. 25, the communications device 2500 may include circuitry for relaying an indication of the model (circuitry 2555).

As shown in FIG. 25, the communications device 2500 may include, stored in computer-readable medium/memory 2530, code for relaying the indication of the model (code 2560).

Various components of the communications device 2500 may provide means for performing the method 1800 described with respect to FIG. 18, or any aspect related to it. For example, means for transmitting, sending, or outputting for transmission may include the transceiver(s) 232 and/or antenna(s) 234 of the BS 110 and/or transceiver 2508 and antenna 2510 of the communications device 2500 in FIG. 25. Means for receiving or obtaining may include the transceiver(s) 232 and/or antenna(s) 234 of the BS 110 and/or transceiver 2508 and antenna 2510 of the communications device 2500 in FIG. 25.

FIG. 25 is provided as an example. Other examples may differ from what is described in connection with FIG. 25.

FIG. 26 is a diagram illustrating an example of an implementation of code and circuitry for a communications device 2600, in accordance with the present disclosure. The communications device 2600 may be a central network entity (such as BS 110 or a disaggregated base station as described with regard to FIG. 3), or a central network entity may include the communications device 2600.

The communications device 2600 includes a processing system 2602 coupled to a transceiver 2608 (e.g., a transmitter and/or a receiver). The transceiver 2608 is configured to transmit and receive signals for the communications device 2600 via an antenna 2610, such as the various signals as described herein. The network interface 2612 is configured to obtain and send signals for the communications device 2600 via communications link(s), such as a backhaul link, midhaul link, and/or fronthaul link as described herein, such as with respect to FIG. 3. The processing system 2602 may be configured to perform processing functions for the communications device 2600, including processing signals received and/or to be transmitted by the communications device 2600.

The processing system 2602 includes one or more processors 2620. In various aspects, the one or more processors 2620 may be representative of one or more of receive processor 238, transmit processor 220, TX MIMO processor 230, and/or controller/processor 240, as described with respect to FIG. 2. The one or more processors 2620 are coupled to a computer-readable medium/memory 2630 via a bus 2606. In various aspects, the computer-readable medium/memory 2630 may be representative of memory 242, as described with respect to FIG. 2. In certain aspects, the computer-readable medium/memory 2630 is configured to store instructions (e.g., computer-executable code, processor-executable code) that when executed by the one or more processors 2620, cause the one or more processors 2620 to perform the method 1900 described with respect to FIG. 19, or any aspect related to it. Note that reference to a processor performing a function of communications device 2600 may include one or more processors performing that function of communications device 2600.

As shown in FIG. 26, the communications device 2600 may include circuitry for receiving, from a UE, UE capability information (circuitry 2635).

As shown in FIG. 26, the communications device 2600 may include, stored in computer-readable medium/memory 2630, code for receiving, from a UE, UE capability information (code 2640).

As shown in FIG. 26, the communications device 2600 may include circuitry for selecting a model based at least in part on the UE capability information (circuitry 2645).

As shown in FIG. 26, the communications device 2600 may include, stored in computer-readable medium/memory 2630, code for selecting a model based at least in part on the UE capability information (code 2650).

As shown in FIG. 26, the communications device 2600 may include circuitry for transmitting, to a core network entity, a model delivery request message (circuitry 2655).

As shown in FIG. 26, the communications device 2600 may include, stored in computer-readable medium/memory 2630, code for transmitting, to a core network entity, a model delivery request message (code 2660).

As shown in FIG. 26, the communications device 2600 may include circuitry for receiving, from the UE, a model delivery complete indication (circuitry 2665).

As shown in FIG. 26, the communications device 2600 may include, stored in computer-readable medium/memory 2630, code for receiving, from the UE, a model delivery complete indication (code 2670).

Various components of the communications device 2600 may provide means for performing the method 1900 described with respect to FIG. 19, or any aspect related to it. For example, means for transmitting, sending, or outputting for transmission may include the transceiver(s) 232 and/or antenna(s) 234 of the BS 110 and/or transceiver 2608 and antenna 2610 of the communications device 2600 in FIG. 26. Means for receiving or obtaining may include the transceiver(s) 232 and/or antenna(s) 234 of the BS 110 and/or transceiver 2608 and antenna 2610 of the communications device 2600 in FIG. 26.

FIG. 26 is provided as an example. Other examples may differ from what is described in connection with FIG. 26.

FIG. 27 is a diagram illustrating an example of an implementation of code and circuitry for a communications device 2700, in accordance with the present disclosure. The communications device 2700 may be a core network entity (such as BS 110 or a disaggregated base station as described with regard to FIG. 3), or a core network entity may include the communications device 2700.

The communications device 2700 includes a processing system 2702 coupled to a transceiver 2708 (e.g., a transmitter and/or a receiver). The transceiver 2708 is configured to transmit and receive signals for the communications device 2700 via an antenna 2710, such as the various signals as described herein. The network interface 2712 is configured to obtain and send signals for the communications device 2700 via communications link(s), such as a backhaul link, midhaul link, and/or fronthaul link as described herein, such as with respect to FIG. 3. The processing system 2702 may be configured to perform processing functions for the communications device 2700, including processing signals received and/or to be transmitted by the communications device 2700.

The processing system 2702 includes one or more processors 2720. In various aspects, the one or more processors 2720 may be representative of one or more of receive processor 238, transmit processor 220, TX MIMO processor 230, and/or controller/processor 240, as described with respect to FIG. 2. The one or more processors 2720 are coupled to a computer-readable medium/memory 2730 via a bus 2706. In various aspects, the computer-readable medium/memory 2730 may be representative of memory 242, as described with respect to FIG. 2. In certain aspects, the computer-readable medium/memory 2730 is configured to store instructions (e.g., computer-executable code, processor-executable code) that when executed by the one or more processors 2720, cause the one or more processors 2720 to perform the method 2000 described with respect to FIG. 20, or any aspect related to it. Note that reference to a processor performing a function of communications device 2700 may include one or more processors performing that function of communications device 2700.

As shown in FIG. 27, the communications device 2700 may include circuitry for receiving, by an AMF of the core network entity from a central network entity, a model delivery request message (circuitry 2735).

As shown in FIG. 27, the communications device 2700 may include, stored in computer-readable medium/memory 2730, code for receiving, by an AMF of the core network entity from a central network entity, a model delivery request message (code 2740).

As shown in FIG. 27, the communications device 2700 may include circuitry for transmitting, by the AMF, a model delivery message that includes an indication of a model (circuitry 2745).

As shown in FIG. 27, the communications device 2700 may include, stored in computer-readable medium/memory 2730, code for transmitting, by the AMF, a model delivery message that includes an indication of a model (code 2750).

Various components of the communications device 2700 may provide means for performing the method 2000 described with respect to FIG. 20, or any aspect related to it. For example, means for transmitting, sending, or outputting for transmission may include the transceiver(s) 232 and/or antenna(s) 234 of the BS 110 and/or transceiver 2708 and antenna 2710 of the communications device 2700 in FIG. 27. Means for receiving or obtaining may include the transceiver(s) 232 and/or antenna(s) 234 of the BS 110 and/or transceiver 2708 and antenna 2710 of the communications device 2700 in FIG. 27.

FIG. 27 is provided as an example. Other examples may differ from what is described in connection with FIG. 27.

The following provides an overview of some Aspects of the present disclosure:
Aspect 1: A method of wireless communication performed by a core network entity, comprising: obtaining, by a model management function (MMF) of the core network entity, a trigger for transmitting meta information associated with a model; transmitting, by the MMF to an access and mobility management function (AMF) of the core network entity, an AMF service invoke message; obtaining, by the AMF, an indication of one or more central network entities within an area; and transmitting, by the AMF to the one or more central network entities, meta information associated with the model.
Aspect 2: The method of Aspect 1, wherein obtaining the trigger comprises obtaining an update to the meta information associated with the model.
Aspect 3: The method of any of Aspects 1-2, wherein obtaining the trigger comprises receiving a request, from the one or more central network entities, for the meta information associated with the model.
Aspect 4: The method of any of Aspects 1-3, wherein transmitting the meta information associated with the model comprises transmitting at least one of a model identifier associated with the model or a model identifier list that identifies the model.
Aspect 5: The method of any of Aspects 1-4, wherein: obtaining the indication of the one or more central network entities within the area comprises obtaining an indication of a plurality of central network entities within the area; and the method further comprises selecting, by the AMF, a central network entity of the plurality of central network entities within the area, wherein transmitting the meta information associated with the model comprises transmitting, by the AMF to the selected central network entity of the plurality of central network entities, the meta information associated with the model.
Aspect 6: The method of any of Aspects 1-5, wherein transmitting the AMF service invoke message comprises transmitting, by the MMF to the AMF, a meta information update indication that includes at least one of a model identifier associated with the model, a model identifier list that identifies the model, the meta information, or an indication of the area.
Aspect 7: The method of Aspect 6, wherein the indication of the area is an indication of a service area or an indication of a geographic area.
Aspect 8: The method of any of Aspects 1-7, further comprising receiving, by at least one of the MMF or the AMF, a meta information update request, and transmitting, by at least one of the MMF or the AMF, a meta information update response.
Aspect 9: The method of Aspect 8, wherein the meta information update request includes a model identifier associated with the model or a model identifier list that identifies the model, and the meta information update response includes meta information associated with at least one of the model identifier associated with the model or the model identifier list that identifies the model.
Aspect 10: The method of any of Aspects 1-9, wherein the meta information indicates at least one of a scenario associated with the model, a configuration associated with the model, a setting associated with the model, a zone identifier associated with the model, a sub-carrier spacing (SCS) associated with an operation of the model, an antenna configuration associated with an operation of the model, carrier information associated with an operation of the model, or bandwidth part information associated with an operation of the model.
Aspect 11: A method of wireless communication performed by a central network entity, comprising: transmitting, to an access and mobility management function (AMF) of a core network entity, a request for meta information associated with a model; and receiving, from the AMF, the meta information associated with the model.
Aspect 12: The method of Aspect 11, wherein the request for the meta information associated with the model includes at least one of a model identifier associated with the model or a model identifier list that identifies the model.
Aspect 13: The method of any of Aspects 11-12, wherein transmitting the request for the meta information associated with the model comprises transmitting a request for updated meta information associated with the model, and receiving the meta information associated with the model comprises receiving updated meta information associated with the model.
Aspect 14: The method of any of Aspects 11-13, wherein the meta information indicates at least one of a scenario associated with the model, a configuration associated with the model, a setting associated with the model, a zone identifier associated with the model, a sub-carrier spacing (SCS) associated with an operation of the model, an antenna configuration associated with an operation of the model, carrier information associated with an operation of the model, or bandwidth part information associated with an operation of the model.
Aspect 15: A method of wireless communication performed by a user equipment (UE), comprising: transmitting, to an access and mobility management function (AMF) of a core network entity, a model query; receiving, from the AMF, a model query response; and selecting a model based at least in part on the model query response.
Aspect 16: The method of Aspect 15, further comprising transmitting, to a central network entity, UE capability information associated with the model.
Aspect 17: The method of any of Aspects 15-16, wherein the model query includes at least one of UE capability information or UE area information.
Aspect 18: The method of Aspect 17, wherein the UE area information is based at least in part on a registration area, wherein the registration area is based at least in part on a tracking area identity or a tracking area code.
Aspect 19: The method of any of Aspects 15-18, wherein the model query response includes at least one of meta information associated with the model or a model identifier associated with the model.
Aspect 20: The method of any of Aspects 15-19, wherein the model query is included in an uplink non-access stratum (NAS) transport message, a class 1 NAS message, a class 2 NAS message, a class 1 message, or a class 2 message.
Aspect 21: The method of any of Aspects 15-20, further comprising transmitting, to the AMF, model management function (MMF) information.
Aspect 22: The method of any of Aspects 15-21, wherein the model query response is included in a registration accept message, a downlink non-access stratum (NAS) transport message, a class 1 NAS message, a class 2 NAS message, a class 1 message, or a class 2 message.
Aspect 23: The method of any of Aspects 15-22, wherein selecting the model based at least in part on the model query response comprises selecting the model based at least in part on meta information included in the model query response.
Aspect 24: The method of any of Aspects 15-23, further comprising: transmitting, to a central network entity, UE capability information; receiving, from the central network entity, a model download request that includes an indication of a model; and transmitting, to the central network entity, a model download complete message.
Aspect 25: The method of Aspect 24, wherein the model download request includes a model identifier or UE assistance information for supporting model selection at a model management function (MMF) of the core network entity.
Aspect 26: The method of Aspect 25, wherein the UE assistance information includes at least one of a carrier frequency indication, a sub-carrier spacing indication, a bandwidth part indication, an antenna tilt indication, an antenna pattern indication, or a scenario, configuration, or zone identifier.
Aspect 27: A method of wireless communication performed by a core network entity, comprising: receiving, by an access and mobility management function (AMF) of the core network entity from a user equipment (UE), a model query, transmitting, by the AMF to a model management function (MMF) of the core network entity, the model query; selecting, by the MMF, a model; transmitting, by the MMF to the AMF, a model query response; and transmitting, by the AMF, the model query response.
Aspect 28: The method of Aspect 27, wherein the model query includes at least one of UE capability information or UE area information.
Aspect 29: The method of Aspect 28, wherein the UE area information is based at least in part on a registration area, wherein the registration area is based at least in part on a tracking area identity or a tracking area code.
Aspect 30: The method of any of Aspects 27-29, wherein the model query response includes at least one of meta information associated with the model or a model identifier associated with the model.
Aspect 31: The method of any of Aspects 27-30, wherein receiving the model query comprises receiving, by the AMF from the UE, an uplink non-access stratum (NAS) transport message, a class 1 NAS message, a class 2 NAS message, a class 1 message, or a class 2 message.
Aspect 32: The method of any of Aspects 27-31, wherein transmitting the model query response comprises transmitting, from the AMF to the UE, a registration accept message, a downlink non-access stratum (NAS) transport message, a class 1 NAS message, a class 2 NAS message, a class 1 message, or a class 2 message.
Aspect 33: A method of wireless communication performed by a network entity, comprising: selecting, by a service management and orchestration (SMO) function of the network entity, a model; and transmitting, by the SMO function of the network entity, an indication of the model.
Aspect 34: The method of Aspect 33, further comprising receiving, from a central network entity, a model delivery request message, wherein transmitting the indication of the model comprises transmitting, by the SMO function of the network entity to the central network entity, the indication of the model.
Aspect 35: The method of Aspect 34, wherein the model delivery request message includes a model identifier associated with the model or user equipment (UE) assistance information.
Aspect 36: The method of Aspect 34, wherein receiving the model delivery request message comprises receiving a radio access network intelligent controller indication message, a class 1 message, or a class 2 message.
Aspect 37: The method of Aspect 34, further comprising: receiving, from a central network entity, user equipment (UE) capability information; determining to initiate an artificial intelligence (AI) or a machine learning (ML) process; and transmitting information associated with the AI or ML process.
Aspect 38: The method of Aspect 37, further comprising receiving UE context information or radio access network information from the central network entity.
Aspect 39: The method of Aspect 37, further comprising requesting UE assistance information from the central network entity.
Aspect 40: The method of Aspect 37, wherein transmitting the information associated with the AI or ML process comprises transmitting the information associated with the AI or ML process to the central network entity.
Aspect 41: The method of Aspect 37, wherein transmitting the information associated with the AI or ML process comprises transmitting the information associated with the AI or ML process to a UE.
Aspect 42: The method of Aspect 37, wherein the information associated with the AI or ML process is associated with a signaling-or-management-based procedure for initializing the AI or ML process or for providing the model to a UE.
Aspect 43: A method of wireless communication performed by a central network entity, comprising: receiving, from a user equipment (UE), UE capability information; selecting a model based at least in part on the UE capability information; transmitting, to a core network entity, a model delivery request message; and receiving, from the UE, a model delivery complete indication.
Aspect 44: The method of Aspect 43, wherein the model delivery request message includes an indication of a model identifier associated with the model.
Aspect 45: The method of any of Aspects 43-44, wherein transmitting the model delivery request message comprises transmitting, to the core network entity, a class 1 message or a class 2 message that includes the model delivery request message.
Aspect 46: The method of any of Aspects 43-45, wherein transmitting the model delivery request message comprises transmitting, to an access and mobility management function, the model delivery request message.
Aspect 47: The method of any of Aspects 43-46, further comprising transmitting, to the UE, a radio resource control message or a medium access control message that indicates that the model is to be received from the core network entity.
Aspect 48: A method of wireless communication performed by a core network entity, comprising: receiving, by an access and mobility management function (AMF) of the core network entity from a central network entity, a model delivery request message; and transmitting, by the AMF, a model delivery message that includes an indication of a model.
Aspect 49: The method of Aspect 48, wherein the model delivery request message includes an indication of a model identifier associated with the model.
Aspect 50: The method of any of Aspects 48-49, further comprising: transmitting, by the AMF to a model management function (MMF) of the core network entity, the model delivery request message; and receiving, by the AMF from the MMF, the model delivery message that includes the indication of the model.
Aspect 51: The method of any of Aspects 48-50, wherein transmitting the model delivery message comprises transmitting, by the AMF to a user equipment (UE), a downlink non-access stratum (NAS) message, a class 1 message, or a class 2 message that includes the model delivery message.
Aspect 52: The method of Aspect 51, further comprising receiving, by the AMF from the UE, a model delivery acknowledgement message.
Aspect 53: The method of Aspect 52, further comprising transmitting, by the AMF to a mobility management function, the model delivery acknowledgement message.
Aspect 54: An apparatus for wireless communication at a device, comprising a processor; memory coupled with the processor; and instructions stored in the memory and executable by the processor to cause the apparatus to perform the method of one or more of Aspects 1-53.
Aspect 55: A device for wireless communication, comprising a memory and one or more processors coupled to the memory, the one or more processors configured to perform the method of one or more of Aspects 1-53.
Aspect 56: An apparatus for wireless communication, comprising at least one means for performing the method of one or more of Aspects 1-53.
Aspect 57: A non-transitory computer-readable medium storing code for wireless communication, the code comprising instructions executable by a processor to perform the method of one or more of Aspects 1-53.
Aspect 58: A non-transitory computer-readable medium storing a set of instructions for wireless communication, the set of instructions comprising one or more instructions that, when executed by one or more processors of a device, cause the device to perform the method of one or more of Aspects 1-53.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules, and circuits described in connection with the present disclosure may be implemented or performed with a general purpose processor, a digital signal processor (DSP), an application-specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices (e.g., a combination of a DSP and a microprocessor, a plurality of microprocessors, one or more microprocessors in conjunction with a DSP core, a system on a chip (SoC), or any other such configuration).

As used herein, the term “determining” encompasses a wide variety of actions. For example, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or a processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus configured for wireless communication, comprising:
one or more memories comprising processor-executable instructions; and
one or more processors configured to execute the processor-executable instructions and cause the apparatus to:
obtain, by a mobility management function (MMF) of a core network entity, a trigger for transmitting meta information associated with a model;
transmit, by the MMF to an access and mobility management function (AMF) of the core network entity, an AMF service invoke message;
obtain, by the AMF, an indication of one or more central network entities within an area; and
transmit, by the AMF to the one or more central network entities, meta information associated with the model.

2. The apparatus of claim 1, wherein the one or more processors, to cause the MMF to obtain the trigger, are configured to cause the MMF to obtain an update to the meta information associated with the model.

3. The apparatus of claim 1, wherein the one or more processors, to cause the MMF to obtain the trigger, are configured to cause the MMF to receive a request, from the one or more central network entities, for the meta information associated with the model.

4. The apparatus of claim 1, wherein the one or more processors, to cause the AMF to transmit the meta information associated with the model, are configured to cause the AMF to transmit at least one of a model identifier associated with the model or a model identifier list that identifies the model.

5. The apparatus of claim 1, wherein the one or more processors, to cause the AMF to obtain the indication of the one or more central network entities within the area, are configured to cause the AMF to obtain an indication of a plurality of central network entities within the area, wherein the one or more processors are configured to cause the AMF to select a central network entity of the plurality of central network entities within the area, and wherein the one or more processors, to cause the AMF to transmit the meta information associated with the model, are configured to cause the AMF to transmit, to the selected central network entity of the plurality of central network entities, the meta information associated with the model.

6. The apparatus of claim 1, wherein the one or more processors, to cause the MMF to transmit the AMF service invoke message, are configured to cause the MMF to transmit, to the AMF, a meta information update indication that includes at least one of a model identifier associated with the model, a model identifier list that identifies the model, the meta information, or an indication of the area.

7. The apparatus of claim 1, wherein the one or more processors are configured to cause at least one of the MMF or the AMF to receive a meta information update request and to transmit a meta information update response, wherein the meta information update request includes a model identifier associated with the model or a model identifier list that identifies the model, and the meta information update response includes meta information associated with at least one of the model identifier associated with the model or the model identifier list that identifies the model.

8. The apparatus of claim 1, wherein the meta information indicates at least one of a scenario associated with the model, a configuration associated with the model, a setting associated with the model, a zone identifier associated with the model, a sub-carrier spacing (SCS) associated with an operation of the model, an antenna configuration associated with an operation of the model, carrier information associated with an operation of the model, or bandwidth part information associated with an operation of the model.

9. An apparatus configured for wireless communication, comprising:
one or more memories comprising processor-executable instructions; and
one or more processors configured to execute the processor-executable instructions and cause the apparatus to:
transmit, to an access and mobility management function (AMF) of a core network entity, a model query;
receive, from the AMF, a model query response; and
select a model based at least in part on the model query response.

10. The apparatus of claim 9, wherein the one or more processors are configured to cause the apparatus to transmit, to a central network entity, UE capability information associated with the model.

11. The apparatus of claim 9, wherein the model query includes at least one of user equipment (UE) capability information or UE area information.

12. The apparatus of claim 9, wherein the model query response includes at least one of meta information associated with the model or a model identifier associated with the model.

13. The apparatus of claim 9, wherein the model query is included in an uplink non-access stratum (NAS) transport message, a class 1 NAS message, a class 2 NAS message, a class 1 message, or a class 2 message.

14. The apparatus of claim 9, wherein the one or more processors are configured to cause the apparatus to transmit, to the AMF, model management function (MMF) information.

15. The apparatus of claim 9, wherein the model query response is included in a registration accept message, a downlink non-access stratum (NAS) transport message, a class 1 NAS message, a class 2 NAS message, a class 1 message, or a class 2 message.

16. The apparatus of claim 9, wherein the one or more processors, to cause the apparatus to select the model based at least in part on the model query response, are configured to cause the apparatus to select the model based at least in part on meta information included in the model query response.

17. The apparatus of claim 9, wherein the one or more processors are configured to cause the apparatus to:
transmit, to a central network entity, user equipment (UE) capability information;
receive, from the central network entity, a model download request that includes an indication of a model; and
transmit, to the central network entity, a model download complete message.

18. The apparatus of claim 17, wherein the model download request includes a model identifier or UE assistance information for supporting model selection at a model management function (MMF) of the core network entity, wherein the UE assistance information includes at least one of a carrier frequency indication, a sub-carrier spacing indication, a bandwidth part indication, an antenna tilt indication, an antenna pattern indication, or a scenario, configuration, or zone identifier.

19. An apparatus configured for wireless communication, comprising:
one or more memories comprising processor-executable instructions; and
one or more processors configured to execute the processor-executable instructions and cause the apparatus to:
receive, by an access and mobility management function (AMF) of a core network entity from a user equipment (UE), a model query,
transmit, by the AMF to a mobility management function (MMF) of the core network entity, the model query;
select, by the MMF, a model;
transmit, by the MMF to the AMF, a model query response; and
transmit, by the AMF to the UE, the model query response.

20. The apparatus of claim 19, wherein the model query includes at least one of UE capability information or UE area information.

21. The apparatus of claim 19, wherein the model query response includes at least one of meta information associated with the model or a model identifier associated with the model.

22. The apparatus of claim 19, wherein the one or more processors, to cause the AMF to receive the model query, are configured to cause the AMF to receive, from the UE, an uplink non-access stratum (NAS) transport message, a class 1 NAS message, a class 2 NAS message, a class 1 message, or a class 2 message, and wherein the one or more processors, to cause the AMF to transmit the model query response, are configured to cause the AMF to transmit, to the UE, a registration accept message, a downlink NAS transport message, the class 1 NAS message, the class 2 NAS message, the class 1 message, or the class 2 message.

23. An apparatus configured for wireless communication, comprising:
one or more memories comprising processor-executable instructions; and
one or more processors configured to execute the processor-executable instructions and cause the apparatus to:
select, by a service management and orchestration (SMO) function of a network entity, a model; and
transmit, by the SMO function of the network entity, an indication of the model.

24. The apparatus of claim 23, wherein the one or more processors are configured to cause the SMO function of the network entity to receive, from a central network entity, a model delivery request message, wherein the one or more processors, to cause the SMO function of the network entity to transmit the indication of the model comprises, are configured to cause the SMO function of the network entity to transmit, to the central network entity, the indication of the model.

25. The apparatus of claim 24, wherein the model delivery request message includes a model identifier associated with the model or user equipment (UE) assistance information.

26. The apparatus of claim 24, wherein the one or more processors, to cause the SMO function of the network entity to receive the model delivery request message, are configured to cause the SMO function of the network entity to receive a radio access network intelligent controller indication message, a class 1 message, or a class 2 message.

27. The apparatus of claim 24, wherein the one or more processors are configured to cause the SMO function of the network entity to:
receive, by the SMO function of the network entity from a central network entity, user equipment (UE) capability information;
determine, by the SMO function of the network entity, to initiate an artificial intelligence (AI) or a machine learning (ML) process; and
transmit, by the SMO function of the network entity, information associated with the AI or ML process.

28. The apparatus of claim 27, wherein the one or more processors are configured to cause the SMO function of the network entity to receive UE context information or radio access network information from the central network entity.

29. The apparatus of claim 27, wherein the one or more processors are configured to cause the SMO function of the network entity to request UE assistance information from the central network entity.

30. The apparatus of claim 27, wherein the one or more processors, to cause the SMO function of the network entity to transmit the information associated with the AI or ML process, are configured to cause the SMO function of the network entity to transmit the information associated with the AI or ML process to at least one of the central network entity or to a UE.
